(19) United States
(12) Patent Application Publication
(10) Pub. No.: US 2019/0332711 A1
(43) Pub. Date: Oct. 31, 2019

(54) INITIALIZATION OF A DISASTER RECOVERY SITE FROM A PHYSICALLY-TRANSPORTED INITIAL DATASET

(71) Applicant: Nutanix, Inc., San Jose, CA (US)

(72) Inventors: Parthasarathy RAMACHANDRAN, Palo Alto, CA (US); Karthik CHANDRASEKARAN, Bangalore (IN); Naveen KUMAR, Bangalore (IN)

(21) Appl. No.: 15/967,416

(22) Filed: Apr. 30, 2018

(51) Int. Cl. G06F 17/30; H04L 9/14; G06F 21/60; H04L 29/08

(52) U.S. Cl. CPC G06F 17/30575; H04L 67/1095; G06F 21/602; H04L 9/14

(57) ABSTRACT

Systems and methods for disaster recovery. The systems and methods serve to synchronize a target computer cluster from data that is physically transported to the target cluster. Steps include collecting data and configuration information pertaining to a primary running computing cluster situated at a first geographic location. Then, that data and those configurations are replicated from the primary running computing cluster to a seeding device configured to store a representation of the primary running computing cluster as a virtual cluster. The seeding device is transported to a location of a secondary computing cluster. At the second geographic location, the seeding device is interfaced to the secondary computing cluster so as to establish the data and configuration information of the primary running computing cluster at the running secondary computing cluster. The representation of the primary running computing cluster includes representation as a single node cluster with a single storage pool.

### FIELD

This disclosure relates to disaster recovery systems, and more particularly to techniques for initialization of a disaster recovery site from a physically-transported initial dataset.

### BACKGROUND

When initially configuring a disaster recovery (DR) site, the duration of time to send data over a network to accomplish an initial load/synchronization of data at the DR site depends on the amount of data of the source site that is to be replicated at the DR site. In modern computing settings, often involving many terabytes or petabytes or more, it is possible that the initial load/synchronization of data at the DR site could take a very long time to complete (e.g., many weeks of ongoing communications over the network).

Unfortunately, given the value of data and given the nature of commitments of service level agreements that demand very rapid recovery from a disaster, running the source site for such a long time without have a fully established disaster recovery capability is often unacceptable to most computing site managers. Moreover, in modern disaster recovery settings, computing at the source site is ongoing, which brings in the complication that disaster recovery operations have to account for the fact that computing processes are running at the source site.

What is needed is a way to rapidly bring up a geographically distant secondary computing site even when the amount of data to be brought up at the secondary computing site is far too voluminous to communicate efficiently over a network.

### SUMMARY

The present disclosure describes techniques used in systems, methods, and in computer program products for initialization of a disaster recovery site from a physically-transported initial dataset, which techniques advance the relevant technologies to address technological issues with legacy approaches. More specifically, the present disclosure describes techniques used in systems, methods, and in computer program products for configuring a secondary computing site from a physically-transported representation of a source computing site. Certain embodiments are directed to technological solutions for physically transporting a representation of very large source site to be established at a geographically distant secondary site.

The disclosed embodiments modify and improve over legacy approaches. In particular, the herein-disclosed techniques provide technical solutions that address the technical problems of rapidly initializing a secondary computing site from a very large dataset of a source computing site. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of computer-to-computer networking as well as advances in various technical fields related to cloud-based data storage.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A depicts a data flow of an initial seeding process as used for configuring a secondary computing site from a physically-transported dataset, according to an embodiment.

FIG. 1B depicts a seeding device registration technique as used for storing a dataset to be physically transported to a second geographic location, according to an embodiment.

FIG. 1C depicts an initial dataset formation technique to generate a secure dataset that can be physically transported to a second geographic location, according to an embodiment.

FIG. 1D depicts an initial seeding technique to load a physically-transported dataset into a computing cluster, according to an embodiment.

FIG. 1E1 depicts a synchronization technique as used for ongoing updating of a secondary computing cluster, according to an embodiment.

FIG. 1E2 depicts a synchronization technique as used to update an initial seed dataset, according to an embodiment.

FIG. 2 depicts a processing flow for bring-up and maintenance of a secondary computing site from a physically-transported representation of a source computing site, according to an embodiment.

FIG. 3A presents a data gathering technique as used in systems for configuring a secondary computing site from a physically-transported dataset, according to an embodiment.

FIG. 3B presents a virtual cluster configuration technique as used in systems for configuring a secondary computing site based on a configuration at a running source cluster, according to an embodiment.

FIG. 3C presents a point-in-time snapshot generation technique as used in systems for configuring a secondary computing site based on a physically-transported configuration snapshot from a running source cluster, according to an embodiment.

FIG. 3D presents an ongoing cluster snapshotting technique as used for configuring a secondary computing site based on a configuration from a continuously running source cluster, according to an embodiment.

FIG. 4A and FIG. 4B present secondary computing site bring-up techniques, according to an embodiment.

FIG. 5A depicts a processing agent in a source cluster environment.

FIG. 5B depicts a processing agent in a target cluster environment.

FIG. 6 depicts system components as arrangements of computing modules that are interconnected so as to implement certain of the herein-disclosed embodiments.

FIG. 7A, FIG. 7B, and FIG. 7C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of how to rapidly initialize a secondary computing site as a disaster recovery site that corresponds to a very large initial dataset of a source computing site. Some embodiments are directed to approaches for physically transporting a representation of the very large initial dataset of a source computing site to the geographically distant secondary site. The accompanying figures and discussions herein present example environments, systems, methods, and computer program products for configuring a secondary computing site from a physically-transported representation of a source computing site such that the secondary computing site can serve as an ongoing disaster recovery site for the source computing site.

### Overview

Disclosed herein are techniques to form a local copy of data and computing entities running on a source computing site and then to save that copy to a non-volatile storage device that is physically transported to a secondary site where it is then used to initialize the secondary computing site. Once the snapshot of data and computing entities of the source computing site have been loaded onto the computing equipment of the secondary site, ongoing replications of data from the source site can be accomplished using network transfers of only the changes that occur or have occurred since the initial formation of the copy of the data and computing entities of the source site.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

System administrators often establish one or more secondary “backup” or “replication” sites that are located at a geographically distant location from a primary site. In case of a disaster that affects the primary site, the backup data stored at the distant site can be used to restore the primary site. In many cases, such one or more secondary sites are established early in the lifecycle of the primary site, in which case the amount of data to initially populate at the secondary site is relatively small, and such a relatively small amount of data can be transmitted over a packet-switched network.

However, over time, the amount of data stored at the primary site typically gets larger. At some point it can happen that the amount of data stored at the primary site can be in the many hundreds of terabytes, or more. Thus, if the system administrator undertakes to populate or seed a secondary site with those many hundreds of terabytes, the amount of network traffic is commensurately as large. In fact, given such a case of many hundreds of terabytes to be transmitted over a network from a primary site to a secondary site, it can take many weeks for the initial seeding of the secondary site to complete.

One alternative is to make a local copy at the source site and store that data on a seeding device (e.g., an array of hard drives or other persistent storage devices), then to physically transport the seeding device to the secondary site, and then to populate storage on the secondary site using data on the seeding device. When the amount of data to be initially seeded is large, it may take much less time to physically transport the seeding device as compared to syncing the data over the network. Once the initial seeding has been completed, then changes to the data at the primary site—which may have occurred during transportation of the seeding device—can be transferred to the secondary site using network communications. Typically, the time period that elapses during transportation of the seeding device is a relatively short time period, thus the changes which may have occurred at the primary site during transportation can reasonably be communicated to the secondary site using network facilities.

Embodiments further address complications that arise when the data to be physically transported (and later updated over a network) is data taken from a running system. Specifically, the data to be physically transported needs to be saved to the seeding device in a consistent state. As such, it is not only the working data (e.g., files, folders, disks, virtual disks, etc.) that are stored in storage devices of the source site that needs to be saved to the seeding device, but also characteristics of the computing environment, including characteristics of hardware components and processes that are active on the source site at the time the seeding device is populated. Still further, many source sites establish a virtualization environment, where any combinations of disparate hardware are virtualized into virtualized entities such as virtual disks (vDisks), virtual network interface cards (vNICS) and other virtualized entities. In virtualized environments, the characteristics of the computing environment include characteristics of such virtualized entities (e.g., state, buffer contents, etc.) as well as characteristics of the hardware underlying the virtualized entities (e.g., execution context, memory allocations, etc.).

As can be seen, inasmuch as the source site exhibits the aforementioned complications, restoring to a target site is commensurately complicated. Strictly as one example, names of entities at the source site might conflict with names as a target site, therefore, even though some portions of the data to be brought into the target site might be brought in bit-for-bit as static data (e.g., as in unchanged contents of a file), there are other portions of the data to be brought into the target site that have to be modified in order to be reconciled with the namespaces and then-current execution states of the target site.

The following sequence of figures provide a schematic depiction of one embodiment of how to bring up a secondary site based on performing disaster recovery operations, first to a seeding device (from a primary site), and then to a secondary site (from the seeding device). The disclosed embodiment includes steps for encryption of the data that is stored onto the seeding device as well as steps for authenticated decryption of data at the secondary site once the seeding device has been physically transported.

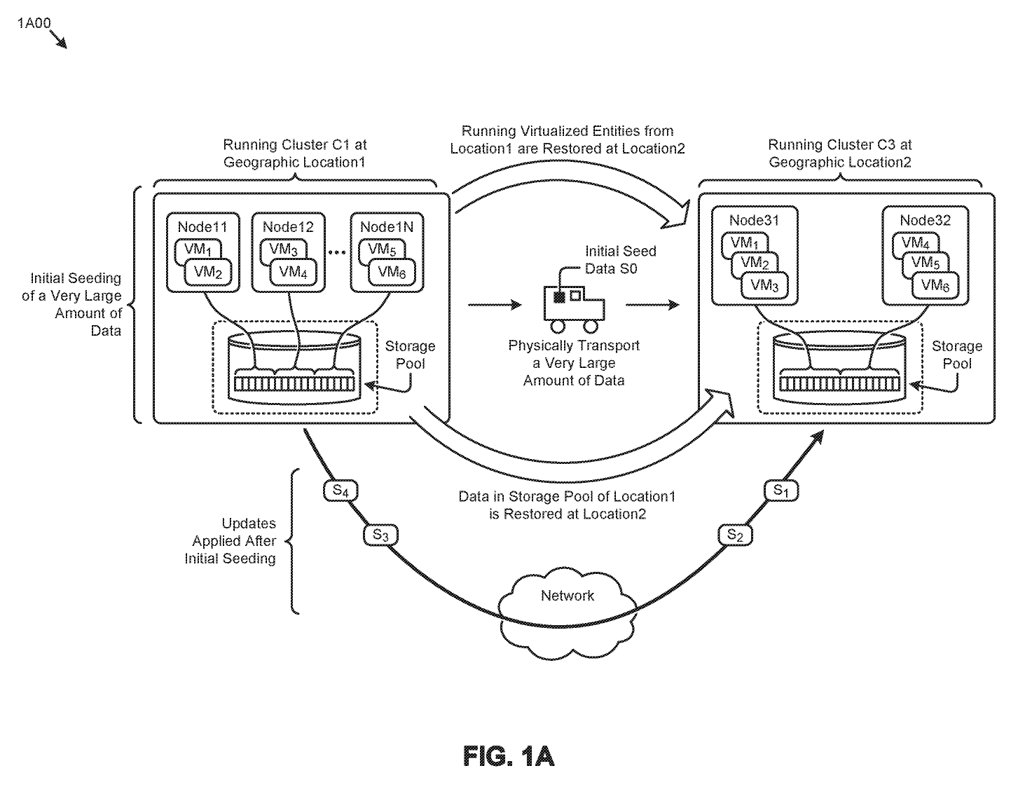

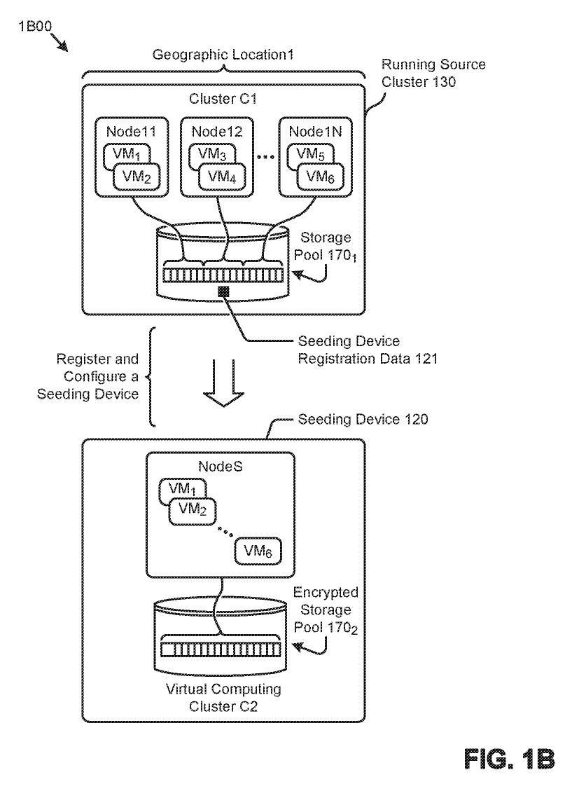

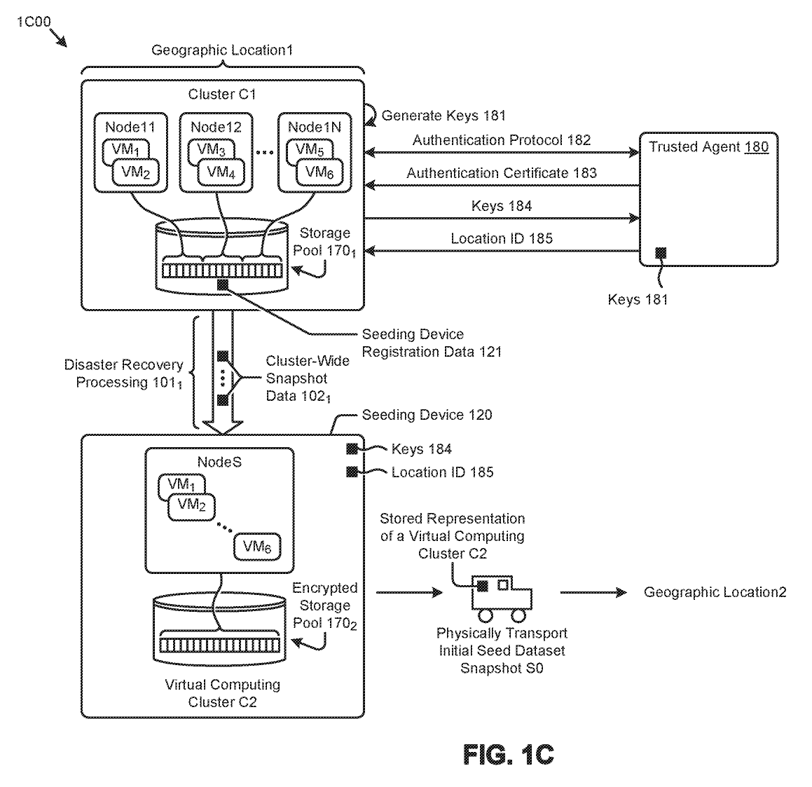

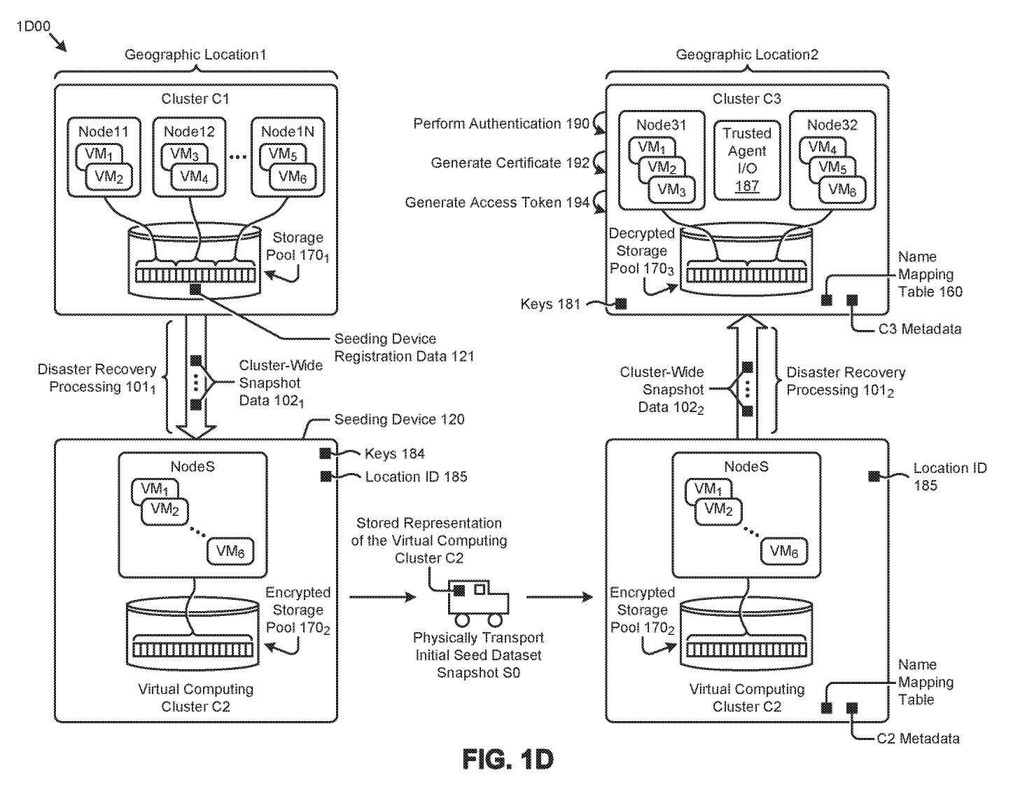

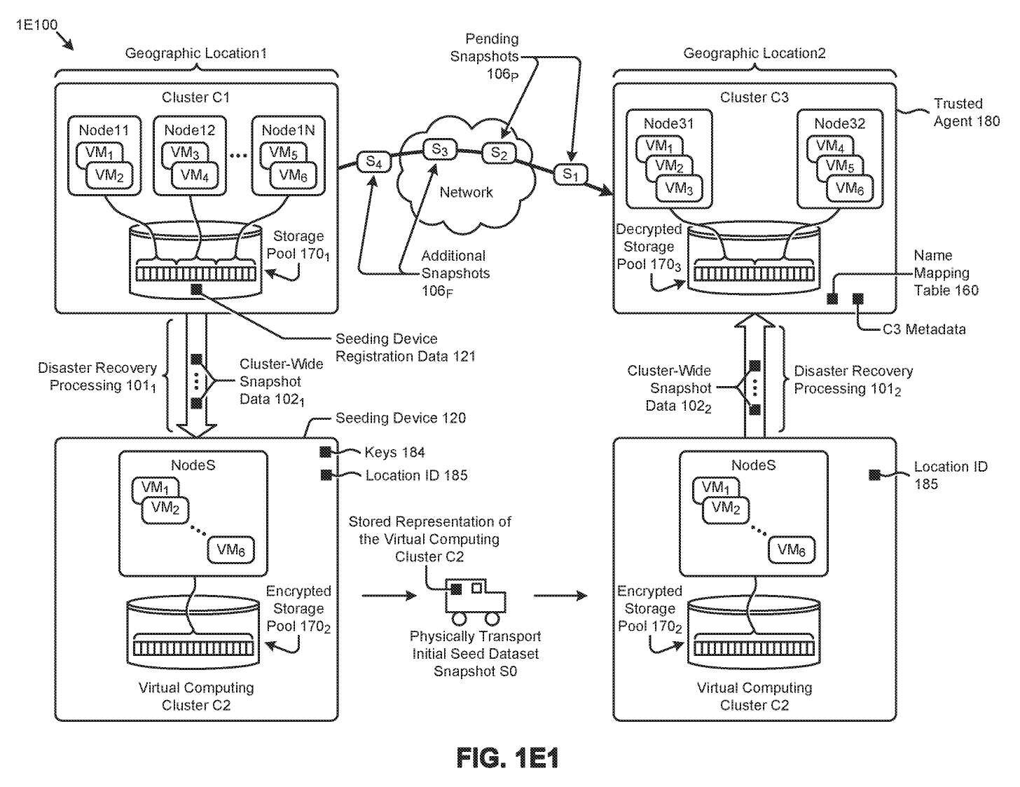

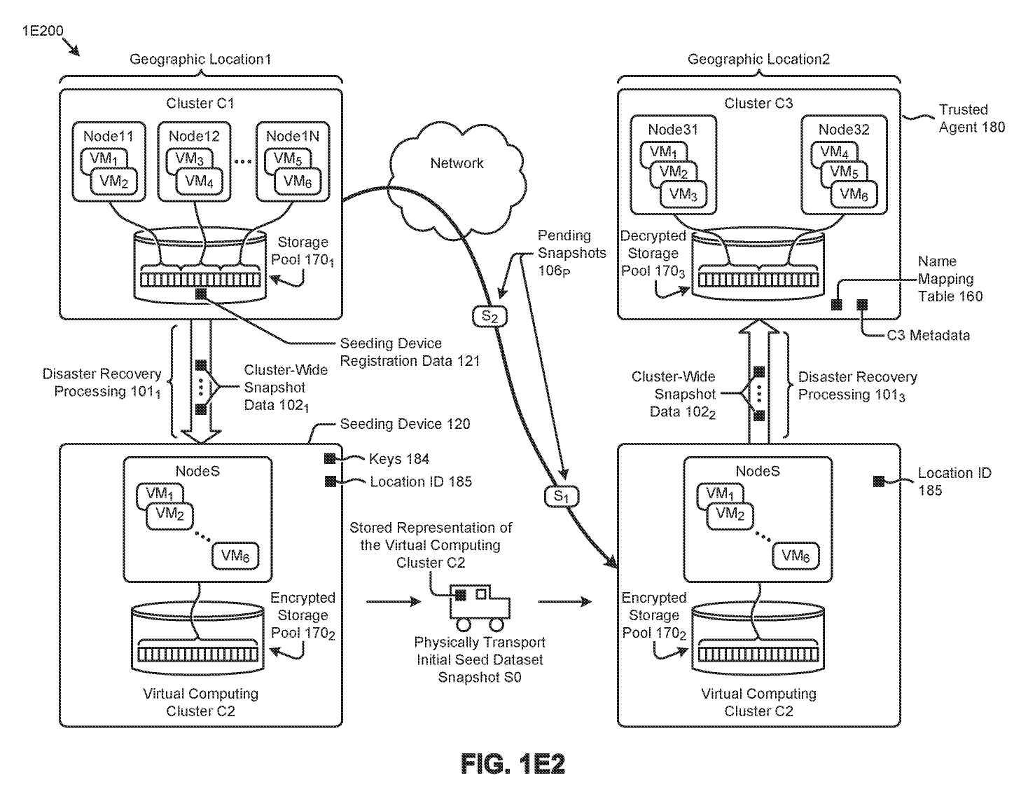

FIG. 1A depicts a data flow of an initial seeding process 1A00 as used for configuring a secondary computing site from a physically-transported dataset. As an option, one or more variations of initial seeding process 1A00 or any aspect thereof may be implemented in the context of the architecture and functionality of the embodiments described herein. The initial seeding process 1A00 or any aspect thereof may be implemented in any environment.

FIG. 1A illustrates one approach to bringing up a computing cluster at a secondary site using a combination of data and configurations that arrive to the computing cluster at a secondary site by firstly, physically transporting an initial seed dataset on a seeding device (e.g., a seeding device that is populated from a running cluster at a first geographic location). Secondly, after physically transporting the seeding device to the second geographic location and bringing the initial seed dataset online at the secondary site (e.g., using the seeding device), network communications re used to update the data and configurations of the secondary site into synchrony with the primary site.

As shown, an initial seeding of a very large amount of data is accomplished by making a copy of the storage pool at geographic location1 onto the seeding device. This is depicted by the counterclockwise arrow that represents that data in the storage pool of the running cluster C1 at location1 is (1) copied to physical storage of the seeding device, (2) transported to location2 and then, (3) restored as data in a storage pool at running cluster C3. After making such a copy, any known method of transportation can be used to transport the seeding device with the initial seed data S0 from geographic location1 to geographic location2. When the seeding device arrives at geographic location2, it is brought online in the running cluster at geographic location2 such that the initial seed data S0 is organized onto storage devices at geographic location2.

In addition to bringing the seeding device online at location2, and in addition to configuring the storage pool at location2, the execution states of any virtualized entities from running cluster C1 are brought up in the context of running cluster C3.

After bringing-up the initial seed data S0 at running cluster C3, and after bringing-up the execution states of any virtualized entities (e.g., virtual machines, virtual network interfaces, etc.) from running cluster C1 the shown network can be used to transmit updates to be applied to the initial seed data S0 and/or to any virtualized entities that are still active in running cluster C1 that correspond to virtualized entities that have been brought up in running cluster C3. In this example, snapshots S1, S2, S3, and S4 represent changes that occur at the running cluster C1 at geographic location1, which changes are sent over the shown network to be applied in the environment of running cluster C3.

Strictly as an illustration, snapshot 51 and snapshot S2 are representative of storage pool data and/or execution context data that had changed at the running cluster at geographic location1 during transportation time (e.g., during the time from storage onto the seeding device at geographic location1 until bring-up at geographic location2), while snapshot S3 and snapshot S4 are representative of ongoing changes at the running cluster at geographic location1 that are to be applied at geographic location2 so as to keep the data and configurations of the running cluster at geographic location2 in synchrony with the data and configurations of the running cluster at geographic location1.

The depictions of FIG. 1B, FIG. 1C, FIG. 1D, FIG. 1E1 and FIG. 1E2 exemplify various sets of operations that are performed over time so as to perform initialization and ongoing synchronization of a disaster recovery site from a physically-transported initial dataset. The flow of FIG. 1B, FIG. 1C, FIG. 1D, FIG. 1E1 and FIG. 1E2 begins with operations for seeding device registration.

FIG. 1B depicts a seeding device registration technique 1B00 as used for storing a dataset to be physically transported to a second geographic location. As an option, one or more variations of the seeding device registration technique 1B00 or any aspect thereof may be implemented in the context of the architecture and functionality of the embodiments described herein. The seeding device registration technique or any aspect thereof may be implemented in any environment.

As shown, cluster C1 is situated at geographic location1. The seeding device is connected using any known technique to cluster C1 for high-performance data transfer. In example embodiments, the seeding device is an array of hard drives that are physically situated in or near cluster C1 such that sustained high-speed movement of data can be accommodated. In example embodiments, the seeding device is an array of hard drives that are organized as logical units of a storage area network (SAN) that supports, for example, high-speed Fibre-channel communications such that sustained high-speed movement of data can be accommodated.

The cluster C1 registers (e.g., which recognizes, mounts, establishes a local communication link, etc.) the seeding device 120 and stores seeding device registration data 121. The seeding device registration data 121 might comprise a set of characteristics of the seeding device and/or characteristics of any aspect of the interface between cluster C1 and the seeding device. For example, if the seeding device is initially configured as a set of logical units of drives, a set of logical unit numbers (LUNs) might be included in the seeding device registration data 121.

Prior to the aforementioned registration process, a system administrator might determine the size (e.g., in terabytes, in petabytes, in exabytes, etc.) of the data and configuration at running cluster C1. Based on the size, the administrator might procure a seeding device that is large enough (e.g., with respect to storage size) and/or capable enough (e.g., with respect to data transfer speeds and sustainability of such transfer speeds) to be able to serve as a seeding device. In some cases, and as heretofore mentioned, the seeding device is merely a collection of high capacity storage devices. However, in other cases, the seeding device is a computing system having one or more processors in addition to the high capacity storage devices. In some cases, and as shown in FIG. 1B, the seeding device comprises a computing node capable of hosting any number of virtual machines (e.g., the shown virtual computing cluster C2), any or all of which virtual machines avail of a cluster-specific storage pool. Inasmuch as the seeding device might contain data that is proprietary to the operator of cluster C1, and inasmuch as the seeding device might be transported by unbonded carriers, the seeding device supports storage of encrypted data into its local encrypted storage pool 1702.

In some cases, rather than having a system administrator determine the size of the data of cluster C1, and rather than having the administrator take steps to procure a seeding device, an agent or third party might assess the size of the data of cluster C1 and automatically specify a correspondingly sized seeding device. Such a correspondingly sized seeding device can be delivered to the administrator of the cluster at geographic location1. As such, the administrator need only to provide the shipping address of their location and the seeding device will be shipped to that specified address. In some cases, the seeding device is physically and/or logically configured to be interfaced with a particular cluster type and or cluster configuration. Strictly as an example, a seeding device can be a group of SATA storage devices that include physical connectors that are compatible with the cluster. Or a seeding device can be “small” cluster (e.g., embodied in a 2U drawer) that can be interface with a larger cluster (e.g., by physically inserting, for instance, a 2U drawer into a chassis that supports multiple drawers).

Regardless of the physical or logical characteristics of seeding device 120, the running source cluster 130 can register the seeding device. As part of the process of registering the seeding device with or by the source cluster, the source cluster stores seeding device registration data 121, which seeding device registration data might be stored in any location in the storage pool, and/or in any location of any memory device, including any data structures as might be used by an operating system running in or on the running source cluster 130. Once the seeding device has been registered, an initial dataset can be formed on the seeding device. FIG. 1C depicts one possible technique for initial dataset formation.

FIG. 1C depicts an initial dataset formation technique 1C00 to generate a secure dataset that can be physically transported to a second geographic location. As an option, one or more variations of initial dataset formation technique 1C00 or any aspect thereof may be implemented in the context of the architecture and functionality of the embodiments described herein. The initial dataset formation technique 1C00 or any aspect thereof may be implemented in any environment.

FIG. 1C illustrates one aspect pertaining to physically transporting a representation of a very large source site to be established at a geographically distant secondary site. Specifically, the figure is being presented with respect to its contribution to addressing the problem of securely transporting an initial seed dataset from a source site to a secondary computing site.

The embodiment shown in FIG. 1C is merely one example. As shown, the initial dataset formation technique includes interactions between cluster C1 and a facility (e.g., trusted agent 180) for certificate generation, secure key storage, encryption/decryption, and secure key retrieval. Specifically, the figure depicts how keys 181 can be securely generated and stored such that the initial seed dataset can be encrypted (e.g., using the generated key or keys) at the source location (e.g., within the physical confines of geographical location1) and then unencrypted (e.g., using the generated key or keys) at the target location (e.g., within the physical confines of geographical location2) after being physically transported. The security of the data during transportation relies in part on key and certificate exchange with an authentication, encryption and decryption facility (e.g., trusted agent 180). In example cases, the trusted agent 180 or an interface to a trusted agent is a component of a target cluster. In other cases, the trusted agent 180 is operated by a third party.

Several aspects of certificate generation, secure key storage, encryption/decryption, and secure key retrieval are shown in FIG. 1C. Specifically, a module running on cluster C1 at geographic location1 serves to generate one or more keys 181. The key or keys might be some unique identifier pertaining to the cluster and/or its environment, or the key or keys might be randomly-generated. In any such cases, the cluster C1 carries out an authentication protocol 182 with the trusted site in which a key or keys are transmitted. The operations carried out by the trusted agent 180 include generation of an authentication certificate 183. Using the authentication certificate, cluster C1 can then securely send the keys 181 to the trusted agent for secure storage at the trusted agent site and/or its proxies (e.g., networked storage facilities). An identifier to a storage location (i.e., location ID 185) that is located in or accessible by the trusted agent is sent to the source cluster and is, in turn, stored on the seeding device 120. The location ID 185 can be used in a later phase to match that location ID of the cluster at geographic location2 is indeed the intended target that corresponds to the data on the seeding device 120.

The mechanism to generate the aforementioned identifier to a storage location can vary depending on many factors. Strictly as an example, the trusted agent 180 is, or relies on at least in part, a trusted third party. In other cases, for example, the trusted agent is embodied as a module within the cluster at geographic location2. In any such cases, the trusted agent has sufficient information about the cluster at geographic location2 that it can generate a location ID 185. In addition to being received and processed by the source cluster (i.e., Cluster C1), the location ID can be stored on the seeding device such that the seeding device can be verified at the target location as being the seeding device that was intended to be used at the target location for the initial seeding. Thus, unintentional or malicious mix-ups or substitution of one seeding device for another seeding device can be recognized and addressed.

Having thus established the needed certificate(s), key(s), and identifier(s), disaster recovery processing 101₁ can be invoked to write the initial seed dataset to the seeding device. More particularly, when performing the disaster recovery processing, the data can be encrypted so as to be able to physically transport the seeding device without concern for misappropriation of the data.

At the time that the dataset is stored onto the seeding device, the then-current configuration of the target cluster might be known, or it might not be known. Moreover, even if the configuration of the target cluster is known at a particular moment in time, the configuration might change over time (e.g., during transportation of the seeding device). Accordingly, the configuration of the seeding device is as a single node cluster with a storage pool. The disaster recovery operations that serve to move data and configurations from the source cluster to the seeding device are such that first, data is encrypted for storage into the encrypted storage pool 170₂ and, next, configurations of virtual machines of any of one or more nodes of running cluster C1 (e.g., nodel1, nodel2, . . . , node 1N) are retargeted to a single node (e.g., the shown nodeS). In many cases, any data that was referenced by any virtual machine (i.e., VM₁, VM₂, VM₃, VM₄, VM₅, VM₆) of running cluster C1 (e.g., as might have been stored in storage pool 170₁ and accessed by a logical block number) can be stored from the encrypted storage pool 170₂ at the same logical block number. When this encryption/decryption technique is used, the storage pool can be encrypted block by block and decrypted block by block with no change in the size of the storage pool.

In some embodiments, various aspects of the running source cluster are quiesced or suspended. For example, before performing disaster recovery operations that make a copy of the data of a particular virtual machine, that virtual machine might be quiesced while the copy/encryption is in progress. In another example, before performing disaster recovery operations that make a copy of the data of a particular application (e.g., a set of virtual machines), that application might be quiesced while the copy/encryption is in progress. In this manner, the dataset written to the seeding device is consistent.

Further details regarding general approaches to saving consistent copies of data are described in U.S. application Ser. No. 15/178,504 titled “SAVING AND RESTORING STORAGE DEVICES USING APPLICATION-CONSISTENT SNAPSHOTS”, filed on Jun. 9, 2016, which is hereby incorporated by reference in its entirety.

In some embodiments, still additional aspects of the running source cluster are quiesced or suspended. It sometimes happens that during the timeframe needed for generation of the representation of the running cluster C1 at, for instance, geographic location1, into a virtual computing cluster C2, and for loading the physically-transported dataset into a target computing cluster at, for instance, geographic location2, some or all disaster recovery operations between the source cluster and the target cluster might be temporarily suspended. In some situations, rather than suspending disaster recovery operations between the source cluster and the target cluster, disaster recovery operations are merely temporarily redirected to a tertiary storage facility. Thus, any data and/or configuration changes that occur on or at the source cluster are captured in a manner that can be later applied on top of the initial seeding dataset. More specifically, the data and/or configuration changes that might have occurred on or at the running source cluster are captured as pending snapshots in a storage area that can be later retrieved so as to be applied on top of the initial seeding dataset once the initial seeding dataset has been loaded onto the target cluster.

When the seeding device has been populated so as to store a representation of the source cluster as a virtual computing cluster having a single node and a single node storage pool, then the seeding device can be prepared for transportation before being un-registered (e.g., closed, unmounted, ejected, etc.) from the source cluster and moved from the physically secure facility of cluster C1. Such preparation for transportation include steps to first, delete any encryption keys present in the seeding device and, next, delete the certificate and/or other credentials that would allow a malicious actor to know the identity of the trusted agent. In some cases, the aforementioned certificate and/or other credentials might be tagged with an expiration time and, thus, would be deleted or otherwise rendered inoperable upon reaching the expiration time. Thus, since the seeding device no longer includes encryption keys or certificates or other credentials as would be needed to decrypt the initial seed dataset, the seeding device can then be securely transported to the location of the target cluster.

Sometime after arrival of the seeding device at the physical location of the target cluster, the initial seed dataset is loaded into the target cluster as shown and depicted in FIG. 1D.

FIG. 1D depicts an initial seeding technique 1D00 to load a physically-transported dataset into a computing cluster. As an option, one or more variations of initial seeding technique 1D00 or any aspect thereof may be implemented in the context of the architecture and functionality of the embodiments described herein. The initial seeding technique 1D00 or any aspect thereof may be implemented in any environment.

After arrival of the seeding device at the physical location of the target cluster, the initial seed dataset can commence. In the specific embodiment of FIG. 1D, the administrator or user or their proxies would perform authentication 190 using a trusted agent interface 187 that can communicate with any embodiment of trusted agent 180. A new certificate 192 and access token 194 is/are generated, which certificate and access tokens are used in conjunction with the location ID 185 to securely access the stored keys that had been previously stored by the trusted agent. If access to the stored keys is denied for any reason, then the initial seed dataset cannot be decrypted, and thus will not be loaded into the target cluster. On the other hand, if access to the stored keys is permitted as expected, then the decryption key or keys can be used to decrypt the contents of the initial seeding device. In particular, the contents of the encrypted storage pool 1702 can be decrypted block-by-block in any order.

The shown disaster recovery processing 1012 is configured so as to be able to map a virtual machine (e.g., VM₁, VM₂, . . . , VM₆) from the virtual computing cluster C2 into a node of the target cluster C3. In the shown example, VM₁, VM₂ and VM₃ are mapped into node31 and VM₄, VM₅, and VM₆ are mapped into node32.

Furthermore, the shown disaster recovery processing 1012 is configured so as to be able to process the entirety of the encrypted storage pool 1702 into occurrences of snapshots (e.g., the shown cluster-wide snapshot data 1021). An agent within the target cluster (e.g., the shown cluster C3) can process the snapshots as if they had been sent over the network rather than over a local communication channel such as SATA or over a backplane such as an Ethernet or over a Fibre channel backplane.

When processing items (e.g., logical blocks, virtual machine configuration data, virtualized device configuration data, other virtualized entities, etc.) from the snapshots, certain name mapping might be involved. For example, when virtual machine VM₁ of nodeS on cluster C2 is moved into node31 of cluster C3, certain aspects of its configuration and/or naming are modified. In particular, it can happen that the characteristics of the decrypted storage pool 1703 of cluster C3 is different from the encrypted storage pool 1702 of virtual computing cluster C2. For example, it might be that decrypted storage pool 1703 of cluster C3 is much larger, but more sparsely populated, than the encrypted storage pool 1702 of cluster C2. As such, a particular logical block of encrypted storage pool 1702, say “LB0000111”, might be mapped to “LB₈₀₀₀₁₁₁” of decrypted storage pool 1703 in cluster C3. Logical block number remapping is merely one example of name mapping. Any of a variety and/or combination of varieties of name mapping can be codified into the shown name mapping table 160.

In example embodiments, the number of nodes of the primary running computing cluster are different from the number of nodes of the secondary running computing cluster. As such, calculations are performed at running cluster C3 such that the VMs from the virtual cluster are apportioned to a different number of nodes in the target cluster than were present at the source clusters when the seeding device was populated. In some cases, the aforementioned calculations performed at running cluster C3 include load balancing.

After all of the initial seed dataset and/or VMs and/or any other configuration data has been brought into target cluster C3, the data seeding device can be ejected from the target cluster. At this point, the data seeding device has fulfilled its purpose, and the initial seeding data can be overwritten or otherwise “wiped” off of the persistent storage so as to prevent misappropriation. Also, at this point, the keys stored in or by the trusted agent 180 can be deleted. The generated certificates can be deleted or left to expire, and the initial seeding device can be reused. Furthermore, at this point, any of the pending snapshots that had been taken at the source cluster (e.g., the pending snapshots as had been saved in a storage area for later retrieval) can now be loaded onto the target cluster in order to synchronize cluster C3 with cluster C1.

FIG. 1E1 depicts such a synchronization technique. FIG. 1E2 depicts an alternative synchronization technique where the pending snapshots that had been taken at the source cluster for later retrieval are processed on top of the initial seed dataset of the seeding device before being loaded into the target cluster.

FIG. 1E1 depicts a synchronization technique 1E100 as used for ongoing updating of a secondary computing cluster. As an option, one or more variations of synchronization techniques 1E100 or any aspect thereof may be implemented in the context of the architecture and functionality of the embodiments described herein. The synchronization technique 1E100 or any aspect thereof may be implemented in any environment.

As shown, the pending snapshots 106_{P} (e.g., snapshot S1, snapshot S2) are communicated over the network from cluster C1 to cluster C3. These are applied to the decrypted storage pool 170₃. Additional snapshots 106_{F} (e.g., snapshot S3, snapshot S4) are also communicated over the network. Any number of still further occurrences of additional snapshots 106_{F} can be continuously sent to cluster C3 and applied.

In an alternative synchronization technique, the pending snapshots can be applied to the initial seeding dataset before the data in the seeding device is brought into target cluster C3. Such a synchronization technique is shown and described in FIG. 1E2.

FIG. 1E2 depicts a synchronization technique 1E200 as used to update an initial seed dataset. As an option, one or more variations of synchronization techniques 1E200 or any aspect thereof may be implemented in the context of the architecture and functionality of the embodiments described herein. The synchronization technique 1E200 or any aspect thereof may be implemented in any environment.

As shown, pending snapshots 106_{P} are processed onto the virtual computing cluster C2. In many cases, and in particular in the embodiment of FIG. 1E2, the seeding device is an actual computing cluster that has one or more computing nodes that are able to interface to the network and process incoming snapshots. As such, snapshot S1 and snapshot S2 can be processed by the seeding device to apply the pending snapshots to the encrypted storage pool 170₂. The data of the pending snapshots might be encrypted using the same keys and/or certificates as were used to populate the encrypted storage pool 170₂. In another case, the incoming snapshots are decrypted as they come across the network (e.g., using the “https:” protocol) and are stored separately in the virtual computing cluster C2 in a location other than the encrypted storage pool 170₂. In such cases, the data of the snapshots are marked as being already unencrypted such that they are not decrypted again during the disaster recovery processing 101₃.

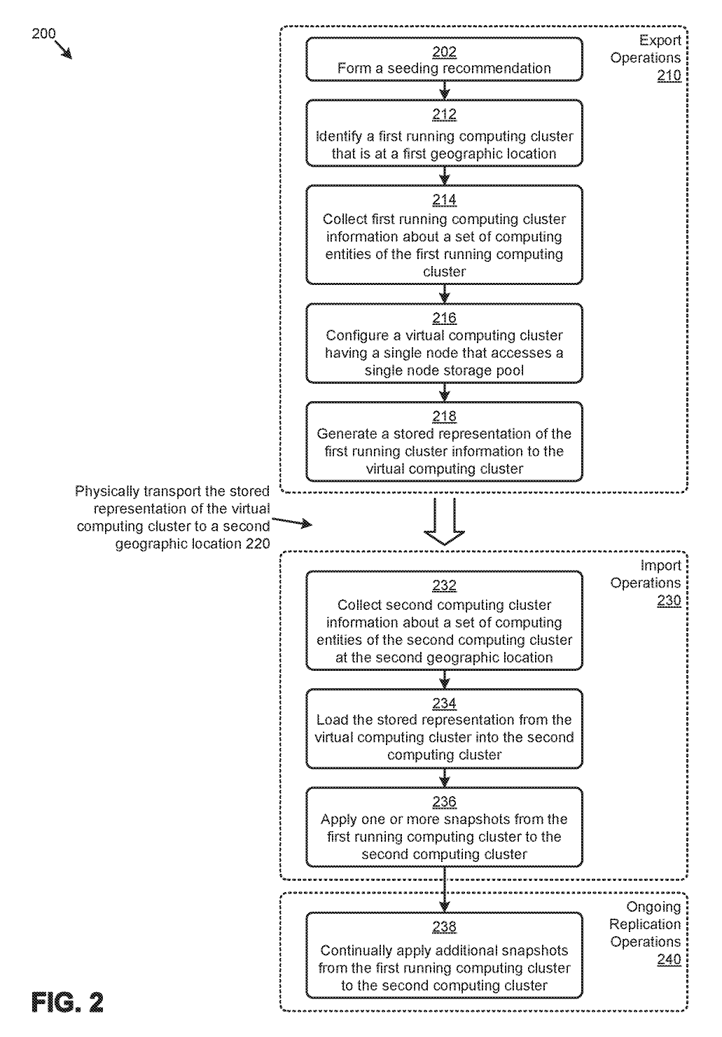

FIG. 2 depicts a processing flow 200 for bring-up and maintenance of a secondary computing site from a physically-transported representation of a source computing site. As an option, one or more variations of processing flow 200 or any aspect thereof may be implemented in the context of the architecture and functionality of the embodiments described herein. The processing flow 200 or any aspect thereof may be implemented in any environment.

The shown flow commences first through a series of export operations 210, followed by a series of import operations 230, and then followed by ongoing replication operations 240. In combination, the operations serve for bring-up and maintenance of a secondary computing site from a physically-transported representation of a source computing site. One sequence of such bring-up and maintenance is shown and described in the succession of figures FIG. 1A through FIG. 1E2. Details pertaining to the export operations, import operations and ongoing replication operations are now briefly discussed.

The export operations 210 commence by automatic formation of a recommendation (step 202) as to how to manage initial seeding of a disaster recovery site. The recommendation is based at least in part on the amount of data to be initially replicated to the disaster recovery site. If the initial amount is relatively small, then the initial seeding can be surmounted by network communication. However, if the initial amount is relatively large, then the initial seeding can be surmounted by implementation of the herein-disclosed initial seeding techniques using a seeding device that holds a representation of a source computing site, which seeding device is physically transported to another geography for initial population of a storage devices at the target site.

In some cases, an approximation of the time to communicate the initial seeding data over the network (e.g., over a public switched network, or over a leased line, etc.) is made. That network time approximation is compared with delivery time/latency estimates for known transportation methods (e.g., mail service, package service, courier service, etc.). If the network time approximation would introduce significantly longer latency to bring-up the initial seeding data as compared to the delivery time/latency estimates for known transportation methods, then a physical delivery method for the initial seeding data is recommended to avoid incurring latency associated with communication of a very large amount of data over a network.

The amount of data involved in the initial seeding may be a complex function, possibly involving a raw data amount, provisions in a service level agreement, network speeds and availability, and other factors. Therefore, it is possible that a recommendation that is presented to an administrator may include aspects of how the recommendation was reached.

It is possible in some embodiments that formation of a recommendation may arise as a result of one or more processes that execute from any location. Therefore, in such embodiments, the recommendation and/or accompanying information or reports will identify the running computing cluster (step 212), possibly by including a name of a cluster, an owner, a list of tenants, a source site name, an indication of the geographic location of the source site, etc. In the event that the administrator decides to accept a recommendation to use the technique of physically transporting a representation of the source site to a target site, then operations of step 214 are invoked. Such operations collect information about the source site such that the information needed to be transported can be generated. As can be understood by those skilled in the art, it might take some time to generate a stored representation of the running cluster. The information about the source site might be initially collected at a first time, then collected again at a second, later time so as to be sure that even if data had changed between the first time and the second time, all of the data needed for a consistent dataset is collected.

In the embodiment of FIG. 2, the data and configuration of the source site is to be represented as a virtual computing cluster that is stored on the seeding device. To do so, one or more operations serve to configure (at step 216) a virtual computing cluster that has a single node that accesses a single node storage pool. Representation of the first running cluster at the source site as a virtual computing cluster having a single node and a single node storage pool is merely illustrative. Other configurations of the stored representation are possible.

In this example, representation of the cluster at the source site as a virtual computing cluster having a single node and a single node storage pool is a matter of convenience such that during import operations, the loading of virtual machines from the virtual computing cluster into the cluster at the target site can involve a one-to-many loading (e.g., from the one node of the stored virtual computing cluster to as many nodes as are used at the target cluster). This one-to-many loading regime is often simpler than various forms of many-to-many loading regimes. When the virtual computing cluster has been configured, certain operations at the running computing cluster can be temporarily quiesced and/or temporarily suspended. The data and configurations pertaining to the stored virtual computing cluster are copied (at step 218) from the running cluster to the seeding device. The seeding device is then disconnected from the source cluster and packaged for physical transportation (at event 220) to the second geographic location where the target cluster is situated.

When the seeding device is received at the second geographic location where the target cluster is situated, and administrator can connect (e.g., physically connect, logically mount, etc.) the seeding device to the second computing cluster. The target computing cluster includes a process or agent that recognizes the characteristics of the seeding device and, together with any needed administrative authorizations, begins a series of import operations 230 that serve to initially populate the target cluster with the initial data and configurations of the source cluster. Specifically, one step of the import operations involves collecting information (at step 232) about the target cluster. This information is used during loading of the data and configurations (at step 234) from the seeding device into the target cluster. As earlier indicated, the virtual machines that are represented as being assigned to the single node of the representation on the seeding device are loaded into nodes of the target cluster. The target cluster may have a single node, thus facilitating a one-node-to-one-node mapping of VMs into the target cluster, or the target cluster may have a plurality of nodes, thus facilitating a node-wise balanced mapping of VMs into the target cluster.

After the data and configurations of the stored representation on the seeding device have been loaded into the target cluster, the process or agent that is performing the series of import operations 230 communicates with the source cluster to request the snapshots that had been generated during the timeframe between ejection of the seeding device at the source cluster and ejection of the seeding device at the target cluster. The target cluster applies (at step 236) any such snapshots. The target cluster and source cluster are now substantially in sync, and the target cluster can serve as a disaster recovery site for the source cluster.

If there were any operations of the source cluster that had been earlier temporarily suspended or temporarily reconfigured (e.g., snapshot generation operations), those operations can be reconfigured and/or resumed to carry out ongoing disaster recovery operations. Specifically, ongoing replication of operations 240 serve to continually apply snapshots (step 238) from the source cluster to the second cluster.

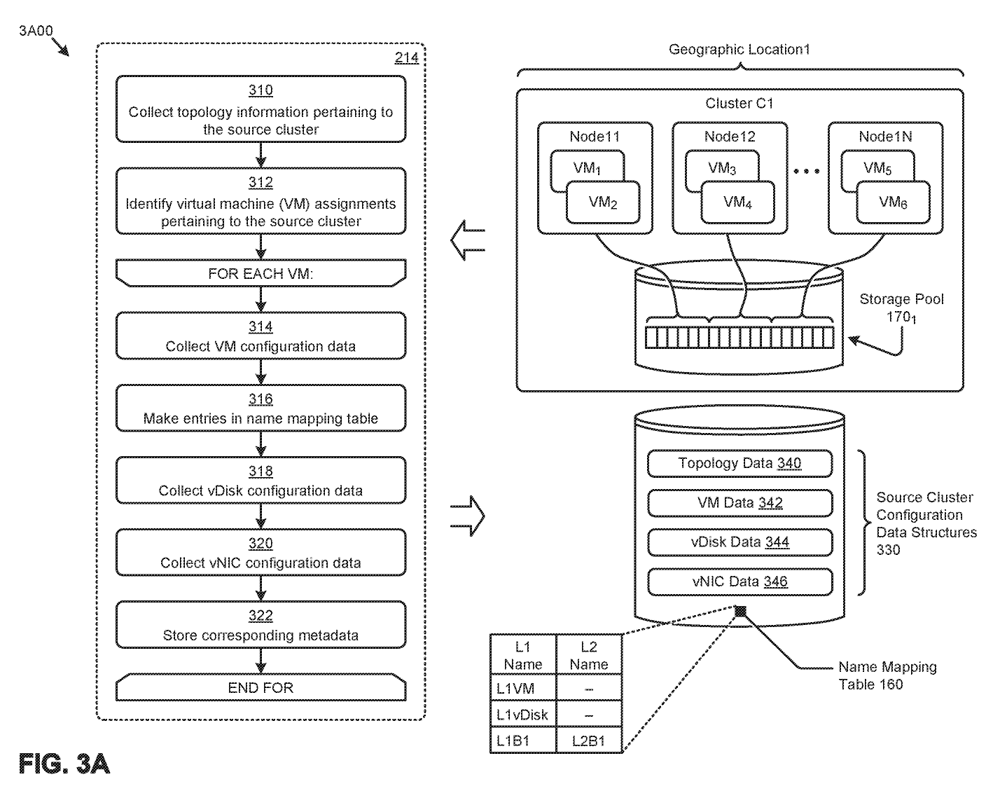

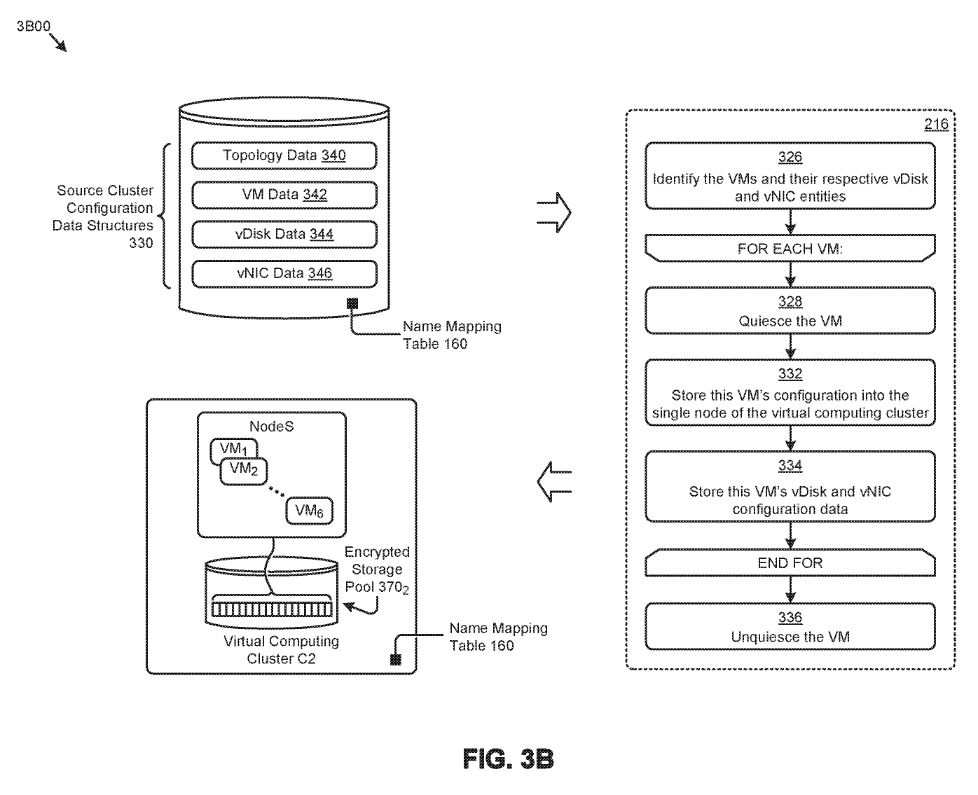

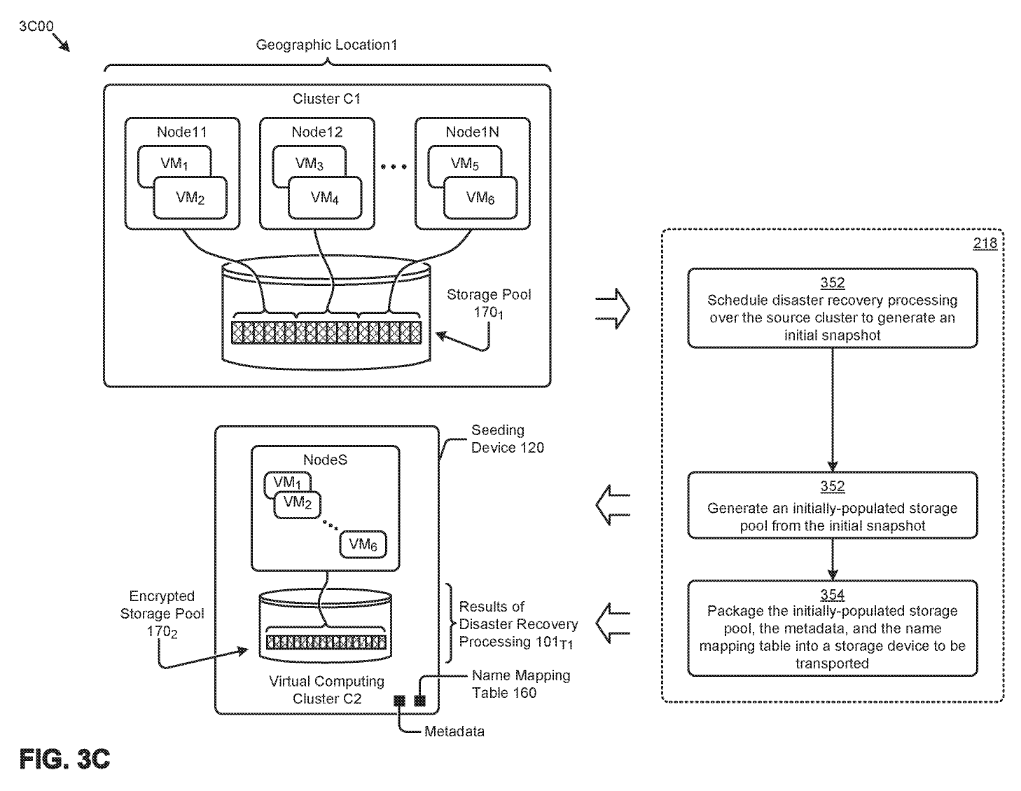

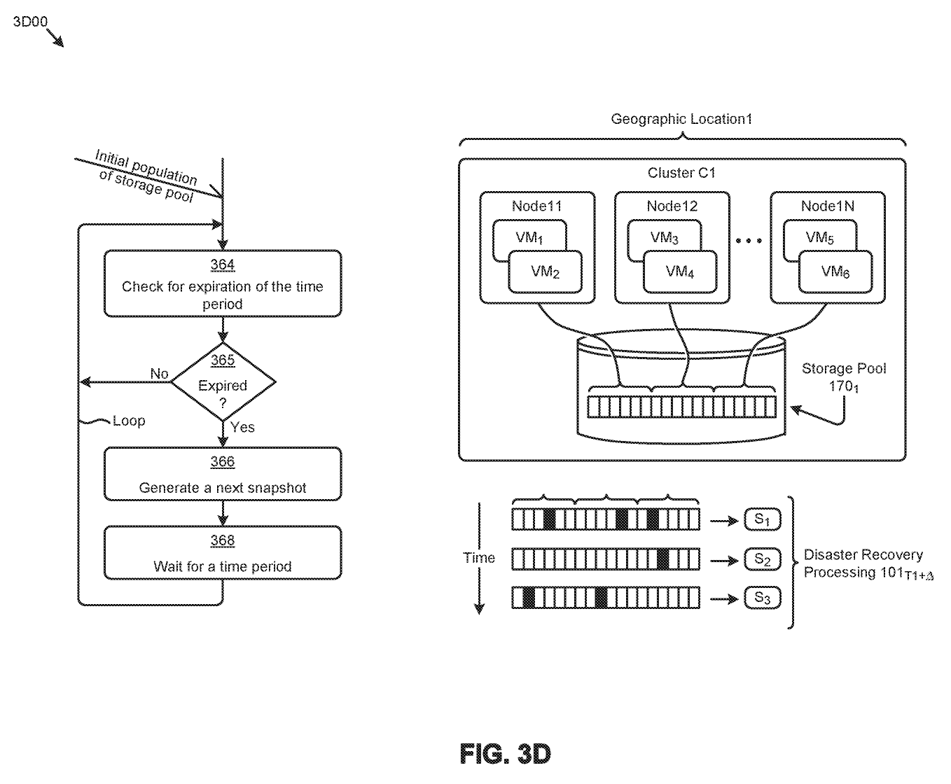

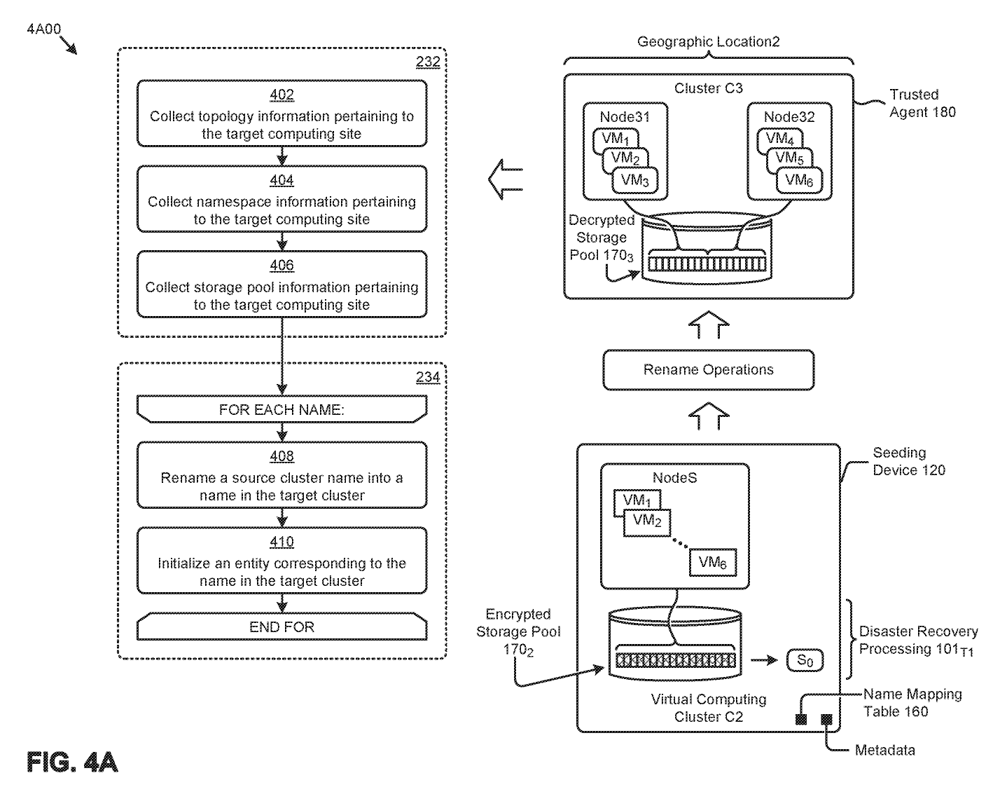

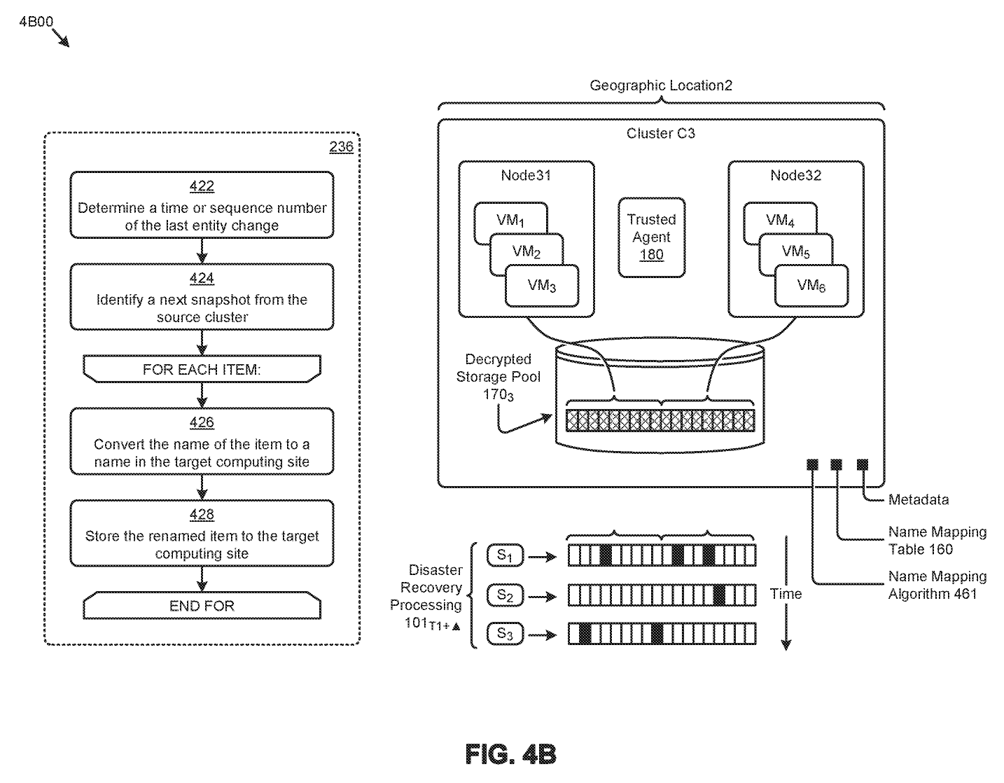

The embodiment shown in FIG. 2 is merely one example partitioning. Other partitions are possible. In the shown partitioning, the export operations 210 include steps for gathering of information about the source cluster, configuring a virtual computing cluster based on the collected data and/or findings, and generating a stored representation of the source cluster that is stored on the seeding device at a virtual computing cluster. Details pertaining to such export operations 210 are shown and described as pertains to FIG. 3A, FIG. 3B, FIG. 3C and FIG. 3D. Furthermore, details pertaining to the import operations 230 are shown and described as pertains to FIG. 4A and FIG. 4B.

FIG. 3A presents a data gathering technique 3A00 as used in systems for configuring a secondary computing site from a physically-transported dataset. As an option, one or more variations of data gathering technique 3A00 or any aspect thereof may be implemented in the context of the architecture and functionality of the embodiments described herein. The data gathering technique 3A00 or any aspect thereof may be implemented in any environment.

The aforementioned data and configuration of the source cluster can be gathered using any known technique. In the specific technique of FIG. 3A, cluster topology information and virtual machine configurations of the source cluster (e.g., cluster C1) are collected and stored in a source cluster configuration data structures 330.

One specific embodiment of data gathering technique 3A00 commences upon gathering topology information (at step 310) of the source cluster. The topology information might include physical partitioning and capabilities of the source cluster. For example, topology information might include a number and identification of the nodes of the source cluster. In addition to being stored as topology data 340, such topology information might form the basis for iterating through the nodes to identify virtual machines that are assigned to a particular node. For example, at step 312, virtual machines that are assigned to the nodes of the source cluster are enumerated. Then, for each enumerated virtual machine, its corresponding virtual entities are accessed to retrieve virtual entity configuration data. Such virtual entity configuration data is stored in metadata and/or in a name mapping table 160. In some cases, the data gathering technique 3A00 relies, at least in part on virtual machine migration techniques that may be provided by a hypervisor or other operational unit in a virtualized system.

Further details regarding general approaches to virtual machine migration are described in U.S. application Ser. No. 15/233,808 titled “AUTOMATIC APPLICATION MIGRATION ACROSS VIRTUALIZATION ENVIRONMENTS”, filed on Aug. 10, 2016, which is hereby incorporated by reference in its entirety.

To accomplish this, each enumerated virtual machine is iterated over in a FOR EACH loop. Within this loop, for each enumerated virtual machine, an entry is made in a mapping table (at step 316). In some cases, the mapping table is organized as a two-column table, with a first column (e.g., “L1 Name”) referring to the name of the entity as it is used at the first location, and a second column (e.g., “L2 Name”) referring to the name of the entity as it is used at the second location. In some cases, the name of the entity pertaining to the second location might not be known at the time that step 316 is being performed. As such, only the first column (e.g., “L1 Name”) is populated. In other cases, the name of the entity might be known at the time that step 316 is being performed and thus, both the first column and the second column can be populated. During processing at the second location, such as during import operations, the names in the “L1 Name” column are mapped to names that become in-use at the second site. Also, names in the “L2 Name” column become in-use at the second site as of the time of processing the import operations.

During iterations through the FOR EACH loop in which various characteristics of each VM are considered, operations of step 314, step 318 and step 320 serve to collect presence and configuration information pertaining to VMs, vDisks and vNICs, respectively. The VM instances are stored at step 322 as VM data 342, the vDisk configurations are stored as vDisk data 344, and the vNIC configurations are stored as vNIC data 346. As such, the VM data, vDisk data, and vNIC data codify the presence and/or configurations of VMs, vDisks and vNICs that are used in subsequent operations, including during import operations at the target site.

After gathering the aforementioned data as shown and discussed above as pertains to FIG. 3A, further operations are carried out to establish a virtual cluster configuration. Establishing a virtual cluster configuration often involves demands taking steps to ensure that the virtual cluster configuration is consistent within itself. For example, a database-oriented VM might need to complete a transaction before being made ready for seeding. Or, a communications-oriented VM might need to complete a particular portion of a protocol before being made ready for seeding. Or, a storage-oriented VM might need to flush cache buffers to persistent storage before being made ready for seeding. In these and many other situations, various techniques for quiescing a VM can be used. One possible technique for achieving quiescent states so as to capture an internally-consistent virtual cluster configuration based on a VM/vDisk/vNIC configuration at a running source cluster is shown and discussed as pertains to FIG. 3B.

FIG. 3B presents a virtual cluster configuration technique 3B00 as used in systems for configuring a secondary computing site based on a configuration at a running source cluster. As an option, one or more variations of virtual cluster configuration technique 3B00 or any aspect thereof may be implemented in the context of the architecture and functionality of the embodiments described herein. The virtual cluster configuration technique 3B00 or any aspect thereof may be implemented in any environment.

The virtual cluster configuration technique 3B00 serves to establish an internally consistent state of VMs and their constituent virtualized entities. The procedures involved include accessing source cluster configuration data structures 330 so as to identify each VM and their constituent virtualized entities (step 326). Then for each VM, the VM is quiesced (at step 328) and, after waiting for the VM to acknowledge the quiescence request, the VM's quiescent state configuration is stored (at step 332). In some cases, a particular VM uses a vDisk and/or vNIC and, in such cases, that particular VM's vDisk configuration and vNIC configuration data are stored (at step 334) as well. After all of the VMs have been quiesced and their configurations captured, some or all of the VMs can be unquiesced (at step 336). As shown, all of the iterated-over VMs are assigned into the single virtual node, nodeS.

Copying of vDisk data to the seeding device can be deferred until all or a set of VMs have been quiesced. Moreover, any copying of vDisk data can use disaster recovery operations to generate the virtual computing cluster C2 that includes encrypted storage pool 170₂, which in turn holds an initial snapshot of the source cluster. This might involve point-in-time snapshot generation so as to persist many terabytes of data to the seeding device. Inasmuch as this might take many minutes or hours (or more) of time to perform the copying of data to the seeding device, a start time is marked. In a running cluster, disaster recovery operations such as taking additional point-in-time time snapshots can operate so that any of such additional point-in-time time snapshots can be applied at the target site after the initial seeding. The marked start time is used so that the target cluster can apply the correct set of point-in-time snapshots.

FIG. 3C presents a point-in-time snapshot generation technique 3C00 as used in systems for configuring a secondary computing site based on a physically-transported configuration snapshot from a running source cluster. As an option, one or more variations of point-in-time snapshot generation technique 3C00 or any aspect thereof may be implemented in the context of the architecture and functionality of the embodiments described herein. The point-in-time snapshot generation technique 3C00 or any aspect thereof may be implemented in any environment.

As shown, cluster C1 at geographic location1 becomes the subject of disaster recovery processing. Using such disaster recovery processing over storage pool 1701, a copy of the virtual storage pool is generated (step 352). In many cases, though not necessarily all cases, the copy of the virtual storage pool is embodied as an encrypted storage pool 1702. In any such cases, at the time of generation (say, a first time epoch beginning at time=T1), the result of disaster recovery processing 101_{T1} is an initially-populated storage pool (step 352) that is packaged (step 354) into a seeding device.

In many cases, the formation of the virtual storage pool of virtual computing cluster C2 is aided by techniques for capturing consistent snapshots. Such consistent snapshots can be augmented with name mapping tables and/or any metadata that is stored outside of the storage pool.

One approach for capturing consistent snapshots involves forming application-consistent snapshots. When forming an application-consistent snapshot or portions of a snapshot that pertain to application-consistency, an identification is made of an application consistency group that needs to be saved/restored to implement a disaster recovery facility.

Specifically, when forming appropriate snapshot or portion thereof to be saved/restored an application consistency group is identified. In a recovery operation, such a snapshot or portion thereof is associated with new instances of corresponding VMs that are being brought up at the target cluster. The VMs in the application consistency group that are being restored at running cluster C3 are brought up using the data from the appropriate snapshot or portion thereof. Even though the virtualization environment might be different between running cluster C1 and running cluster C3, the VMs within the application consistency group will be restored and brought up with characteristics such that the applications formed of the VMs can start up with the assumption of known or assumed consistency in their restored states.

Further details regarding general approaches to disaster recovery processing for virtual machines are described in U.S. application Ser. No. 15/178,504 titled, “SAVING AND RESTORING STORAGE DEVICES USING APPLICATION-CONSISTENT SNAPSHOTS” filed on Jun. 9, 2016, which is hereby incorporated by reference in its entirety.

Completion of generation of such an initially-populated storage pool raises an event, which event is associated a second time epoch beginning at time=T1+Δ.

Upon completion of the generation of the initially-populated storage pool, the seeding device 120 is loaded with other data pertaining to the virtual computing cluster, namely metadata associated with the storage pool, as well as the aforementioned name mapping table. The seeding device is then ready for physical transportation.

It is understood that the physical transportation of the seeding device to geographic location2 will incur some transportation time, during which time the cluster at geographic location1 continues to run. Accordingly, some technique is needed to capture changes that occur during that transportation time such that those changes at the cluster at geographic location1 can be applied onto the cluster at geographic location2.

FIG. 3D presents an ongoing cluster snapshotting technique 3D00 as used for configuring a secondary computing site based on a configuration from a continuously running source cluster. As an option, one or more variations of ongoing cluster snapshotting technique 3D00 or any aspect thereof may be implemented in the context of the architecture and functionality of the embodiments described herein. The ongoing cluster snapshotting technique 3D00 or any aspect thereof may be implemented in any environment.

As shown, a time-ordered series of snapshots are made and stored in a manner that facilitates later application to a storage pool. The technique commences upon detection of the event of initial population of the storage pool of the virtual computing cluster. In a loop, a timer is activated. A check is made to determine if the timer has expired (step 364). Decision 365 then serves to route processing based on the check. If the time has not expired, then the “No” branch of decision 365 is taken and the timer check is repeated. Otherwise, the “Yes” branch of decision 365 is taken and a next snapshot is generated (at step 366), after which the processing waits a certain time period before looping.

The certain time period before looping is configurable in many dimensions. For example, the time period might be a number of minutes or hours etc., or the time period might be dependent on some storage activity, such as “whenever 100 blocks of data have been changed”, or the time period might be dependent some other measure. Regardless of the waiting time interval incurred at step 368, one or more snapshots are generated by or at cluster C1 at geographic location1. Such snapshots can be retrieved by a cluster at a different location and applied to a storage pool.

FIG. 4A and FIG. 4B present secondary computing site bring-up techniques 4A00 and 4B00. As an option, one or more variations of secondary computing site bring-up techniques 4A00 and 4B00 or any aspect thereof may be implemented in the context of the architecture and functionality of the embodiments described herein. The secondary computing site bring-up techniques 4A00 and 4B00 or any aspect thereof may be implemented in any environment.

FIG. 4A depicts a series of operations to load a cluster (e.g., cluster C3) from a virtual computing cluster that is stored on a seeding device 120. Import operations can begin at some moment after the seeding device has been delivered. The figure includes steps involved in collecting information about the target cluster (e.g., target cluster topology, target cluster entity naming, etc.) as well as steps involved in renaming entities from the name space of the source cluster to entities in the namespace of the target cluster.

At step 402, information pertaining to the topology of the target cluster is gathered. Such topology information often includes the number and type of computing nodes, the number and type of networking interfaces, the number and type of storage devices, etc. Such topology information is used when bringing in virtual machines and their constituent virtual entities from the virtual computing cluster C2 to the target cluster C3.

At step 404, namespace information is gathered. Such namespace information often includes hierarchical name spaces pertaining to computing nodes, hierarchical name spaces pertaining to networking interfaces, hierarchical name spaces pertaining to storage devices, etc. Such namespace information is used when bringing in virtual machines and their constituent virtual entities from the virtual computing cluster C2 to the target cluster C3.

At step 406, storage pool information pertaining to the target cluster is gathered. Such storage pool information pertaining to the target cluster is used when bringing in data from the virtual computing cluster C2. For example, it might be that decrypted storage pool 170₃ of cluster C3 is much larger, but more sparsely populated, than the encrypted storage pool 170₂ of cluster C2. As such, a particular logical block of encrypted storage pool 1702₂, say “LB0000111”, might be mapped to “LB8000111” of decrypted storage pool 170₃ in cluster C3. Logical block number remapping is merely one example of rename operations. Virtual entities of any sort might also be subject to rename operations so as to bring virtual entities from the source cluster into virtual entities in the target cluster.

It often happens that the namespaces of the target cluster are significantly different from the namespaces of the source cluster. As such a FOR EACH loop is entered to perform renaming on all entities. Specifically, a FOR EACH loop is initialized to iterate through all entities of the virtual computing cluster C2. The FOR EACH loop iterates through step 408 and step 410 so as to rename a source cluster name into a name in the namespace of the target cluster and then to initialize a virtual entity in the namespace of the target cluster. Since the pertinent data (e.g., vDisk data) and/or configuration information for a particular virtual entity has been brought into the initialized virtual entity in the namespace of the target cluster then, referring again to step 404, the decrypted storage pool 170₃ is populated with entities that carry a name that is in the namespace of the target cluster (step 410). After the entirety of the virtual cluster C2 has been brought into target cluster C3, snapshots can be applied.

FIG. 4B depicts how a set of time-sequenced snapshots can be applied over the storage pool of target cluster C3. As shown, step 422 and step 424 serve to determine a last time or sequence number of a last snapshot or entity change and then to identify and retrieve a next snapshot (if any). The snapshot is processed in a FOR EACH loop that iterates over each item in the snapshot so as to convert each item in the snapshot from its name on the source cluster to a name on the target cluster (step 426). Any of the renaming techniques of FIG. 4A, or any other known technique can be used in such renaming. Once renamed, step 428 stores the contents (e.g., data or configuration) into the target cluster. In the example depicted, snapshot S1 is first applied, followed by snapshot S2, followed by snapshot S3. In some cases, new virtual entities are created at the source site after completing the transfer of data to the initial seeding device. In such cases, the name mapping table can be used in conjunction with a name mapping algorithm 461 to map the newly-created entity from the source site into a name that is compatible with the namespace of the target site.

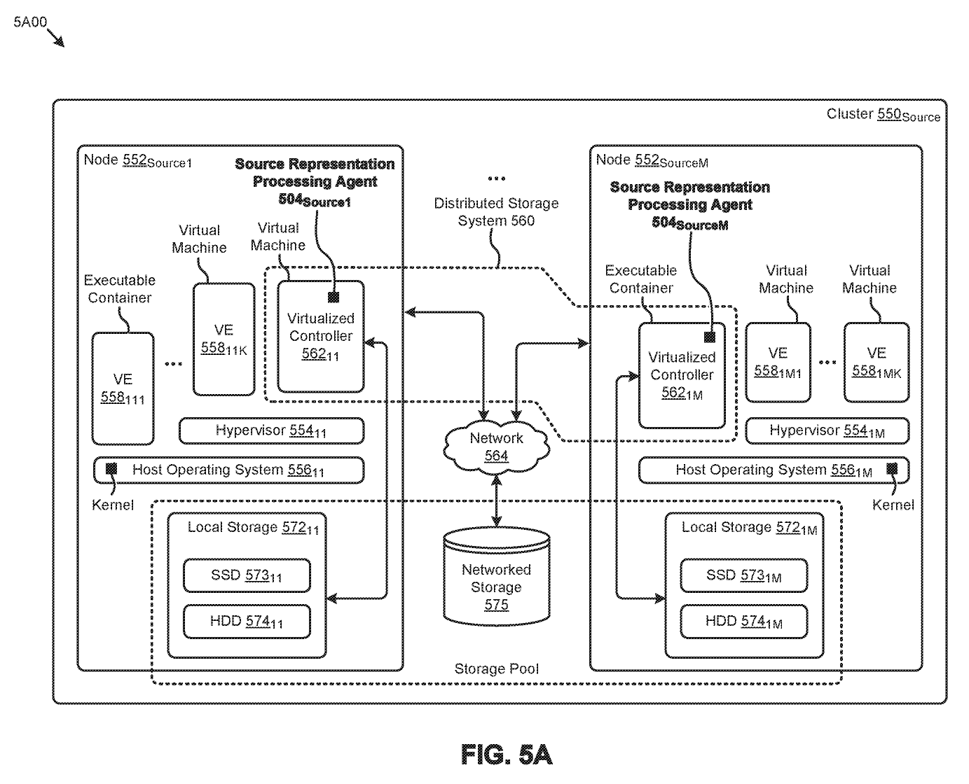

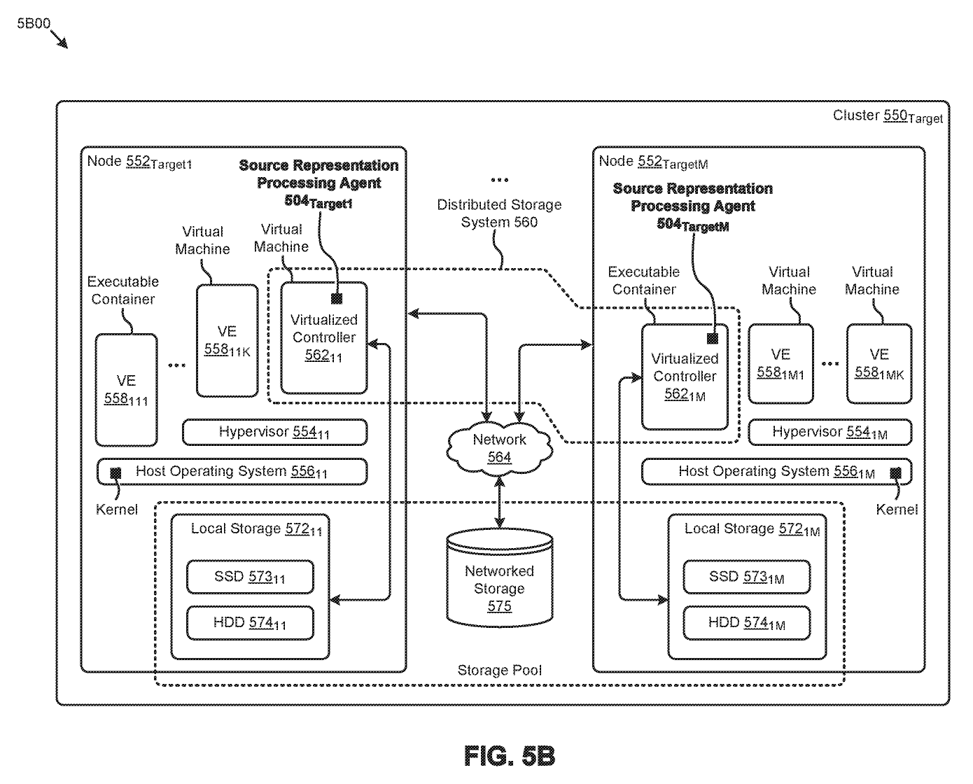

FIG. 5A depicts a processing agent in a source cluster environment 5A00. As an option, one or more variations of source cluster environment 5A00 or any aspect thereof may be implemented in the context of the architecture and functionality of the embodiments described herein.

The shown source cluster environment 5A00 depicts various components associated with instances of distributed virtualization systems (e.g., hyperconverged distributed systems) that can be used to implement the herein disclosed techniques. Specifically, the source cluster environment 5A00 comprises a computing cluster (e.g., cluster 550_{Source}) comprising multiple nodes that have multiple tiers of storage in a storage pool. Representative nodes (e.g., node 552_{Source1}, . . . , node 552_{SourceM}) and storage pool associated with cluster 550_{Source} are shown. Each node can be associated with one server, multiple servers, or portions of a server. The nodes can be associated (e.g., logically and/or physically) with the clusters. As shown, the multiple tiers of storage include storage that is accessible through a network 564, such as a networked storage 575 (e.g., a storage area network or SAN, network attached storage or NAS, etc.). The multiple tiers of storage further include instances of local storage (e.g., local storage 572₁₁, . . . , local storage 572_{1M}). The local storage can be within or directly attached to a server and/or appliance associated with the nodes. Such local storage can include solid state drives (SSD 573₁₁, . . . , SSD 573_{1M}), hard disk drives (HDD 574₁₁, . . . , HDD 574_{1M}), and/or other storage devices.

As shown, any of the nodes of the source cluster environment 5A00 can implement one or more user virtualized entities (e.g., VE 558₁₁₁, . . . , VE 558_{11K}, . . . , VE 558_{1M1}, . . . , VE 558_{1MK}), such as virtual machines (VMs) and/or executable containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 556₁₁, . . . , host operating system 556_{1M}), while the VMs run multiple applications on various respective guest operating systems. Such flexibility can be facilitated at least in part by a hypervisor (e.g., hypervisor 554₁₁, . . . , hypervisor 554_{1M}), which hypervisor is logically located between the various guest operating systems of the VMs and the host operating system of the physical infrastructure (e.g., node).

As an example, hypervisors can be implemented using virtualization software that includes a hypervisor. In comparison, the executable containers (e.g., application containers or ACs) are implemented at the nodes in an operating system virtualization environment or executable container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 556₁₁, . . . , host operating system 556_{1M}) without, in most cases, a hypervisor layer. This lightweight implementation can facilitate efficient distribution of certain software components, such as applications or services (e.g., micro-services). Any node of a source cluster environment 5A00 can implement both a hypervisor-assisted virtualization environment and/or an executable container virtualization environment for various purposes. Also, any node in a source cluster environment 5A00 can implement a virtualized controller to facilitate access to storage pool by the VMs and/or executable containers.

As used in these embodiments, a virtualized controller is a collection of software instructions that serve to abstract details of underlying hardware or software components from one or more higher-level processing entities. A virtualized controller can be implemented as a virtual machine, as an executable container (e.g., a Docker container), or within a layer (e.g., such as a layer in a hypervisor).

Multiple instances of such virtualized controllers can coordinate within a cluster to form the distributed storage system 560 which can, among other operations, manage the storage pool 170. This architecture further facilitates efficient scaling in multiple dimensions (e.g., in a dimension of computing power, in a dimension of storage space, in a dimension of network bandwidth, etc.).

The foregoing virtualized controllers can be implemented in the source cluster environment 5A00 using various techniques. As one specific example, an instance of a virtual machine at a given node can be used as a virtualized controller in a hypervisor-assisted virtualization environment to manage storage and I/O (input/output or IO) activities. In this case, for example, the virtualized entities at node 552_{Source1} can interface with a controller virtual machine (e.g., virtualized controller 562₁₁₎ through hypervisor 554₁₁ to access storage pool 170. In such cases, the controller virtual machine is not formed as part of specific implementations of a given hypervisor. Instead, the controller virtual machine can run as a virtual machine above the hypervisor at the various node host computers.

When the controller virtual machines run above the hypervisors, varying virtual machine architectures and/or hypervisors can operate with the distributed storage system 560. For example, a hypervisor at one node in the distributed storage system 560 might correspond to a first software vendor, and a different hypervisor at another node in the distributed storage system 560 might correspond a different software vendor. As another virtualized controller implementation example, executable containers (e.g., Docker containers) can be used to implement a virtualized controller (e.g., virtualized controller 562_{1M}) in an operating system virtualization environment at a given node. In this case, for example, the virtualized entities at node 552_{SourceM} can access the storage pool by interfacing with a controller container (e.g., virtualized controller 562_{1M}) through hypervisor 554_{1M} and/or the kernel of host operating system 556_{1M}.

In certain embodiments, one or more instances of an agent can be implemented in the distributed storage system 560 to facilitate the herein disclosed techniques. Specifically, a source representation processing agent 504_{Source1} can be implemented in the virtualized controller 562₁₁, and source representation processing agent 504_{SourceM} can be implemented in the virtualized controller 562_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

As earlier described, the problems attendant to rapidly initializing a secondary computing site that corresponds to a very large source computing site can be addressed in the context of the foregoing environment. Moreover, any aspect or aspects of physically transporting a representation of a very large source site to be established at a geographically distant secondary site can be implemented in the context of the foregoing environment.

FIG. 5B depicts a processing agent in a target cluster environment 5B00. As an option, one or more variations of target cluster environment 5B00 or any aspect thereof may be implemented in the context of the architecture and functionality of the embodiments described herein. The target cluster environment 5B00 or any aspect thereof may be implemented in any environment.

The shown target cluster environment 5B00 depicts various components associated with instances of distributed virtualization systems (e.g., hyperconverged distributed systems) that can be used to implement the herein disclosed techniques. Specifically, the target cluster environment 5B00 comprises a computing cluster (e.g., cluster 550_{Target}) comprising multiple nodes that have multiple tiers of storage in a storage pool. Representative nodes (e.g., node 552_{Target1}, . . . , node 552_{TargetM}) and storage pool associated with cluster 550_{Target} are shown. Each node can be associated with one server, multiple servers, or portions of a server. The nodes can be associated (e.g., logically and/or physically) with the clusters. As shown, each node of the cluster (e.g., node 552_{Target1}, . . . , node 552_{TargetM}) hosts a source representation processing agent 504_{Target1} can be implemented in the virtualized controller 562₁₁, and source representation processing agent 504_{TargetM} can be implemented in the virtualized controller 562_{1M}.

The code base for any source representation processing agent can comprise instructions that perform export operations 210 as well as import operations 230. As such, any particular instance of a source representation processing agent can be configured to operation either for performing all or portions of export operations 210, and/or all or portions of import operations 230.

### Additional Embodiments Of The Disclosure

### Additional Practical Application Examples

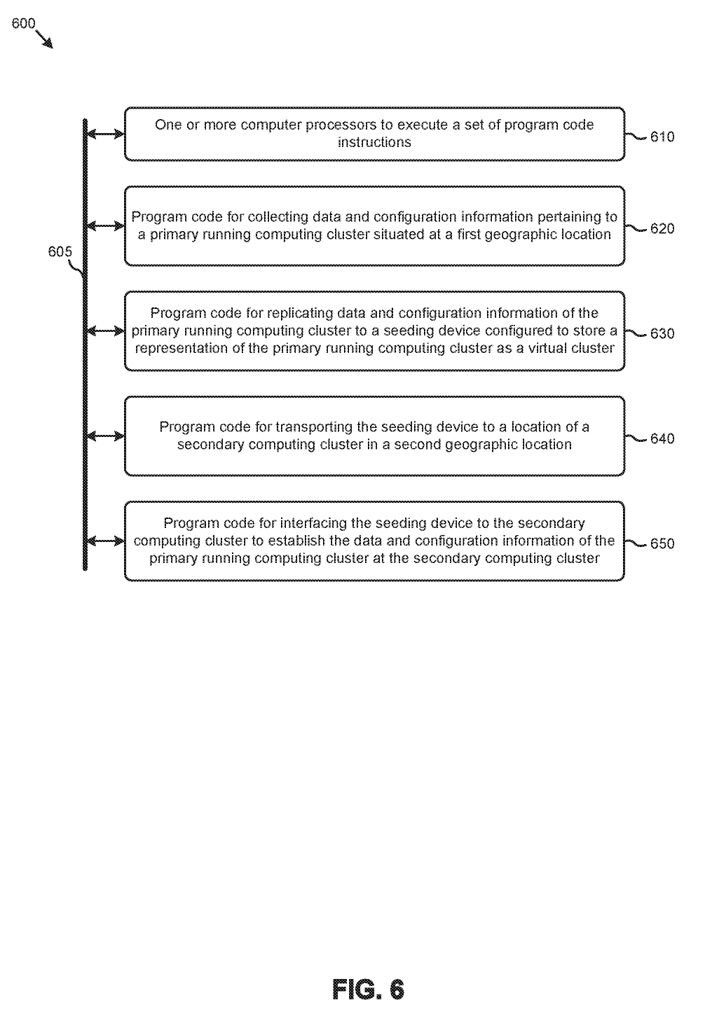

FIG. 6 depicts a system 600 as an arrangement of computing modules that are interconnected so as to operate cooperatively to implement certain of the herein-disclosed embodiments. This and other embodiments present particular arrangements of elements that, individually and/or as combined, serve to form improved technological processes that address rapidly initializing a secondary computing site that corresponds to a very large source computing site. The partitioning of system 600 is merely illustrative and other partitions are possible. As shown, the system 600 incudes a processor (module 610), a bus 605, and modules to carry our operations for: collecting data and configuration information pertaining to a primary running computing cluster situated at a first geographic location (module 620); replicating data and configuration information of the primary running computing cluster to a seeding device configured to store a representation of the primary running computing cluster as a virtual cluster (module 630); transporting the seeding device to a location of a secondary computing cluster in a second geographic location (module 640); and interfacing the seeding device to the secondary computing cluster to establish the data and configuration information of the primary running computing cluster at the secondary computing cluster (module 650).

Variations of the foregoing may include more or fewer of the shown modules. Certain variations may perform more or fewer (or different) steps and/or certain variations may use data elements in more or in fewer (or different) operations.

### System Architecture Overview

### Additional System Architecture Examples

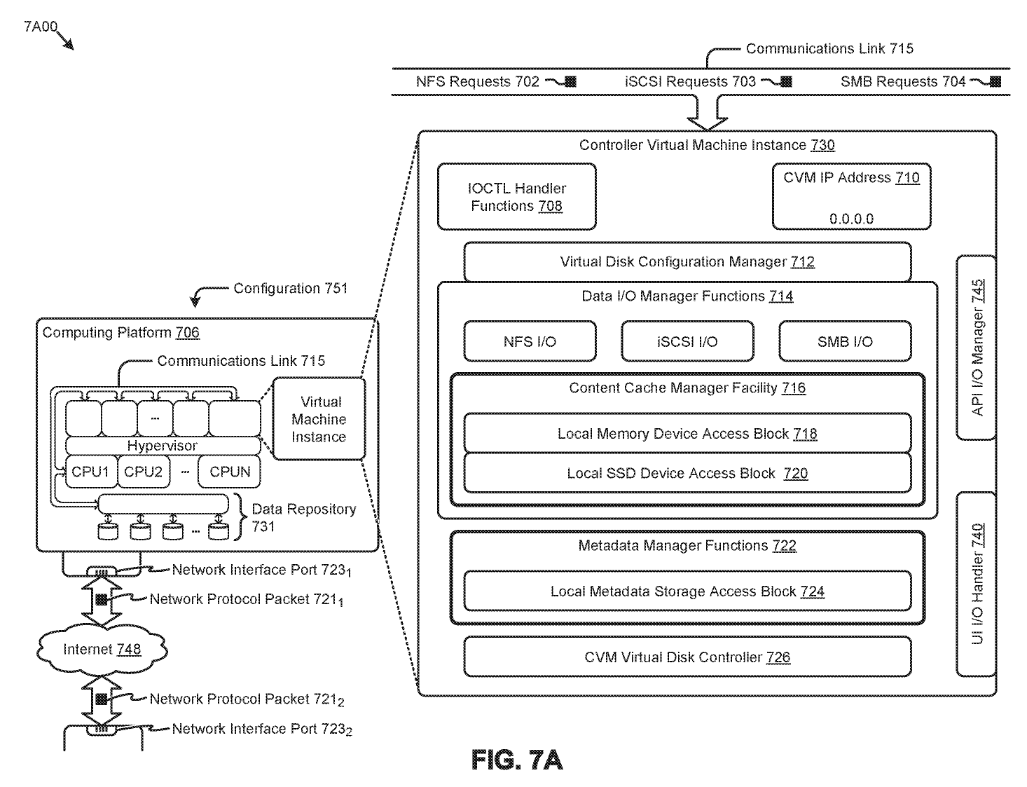

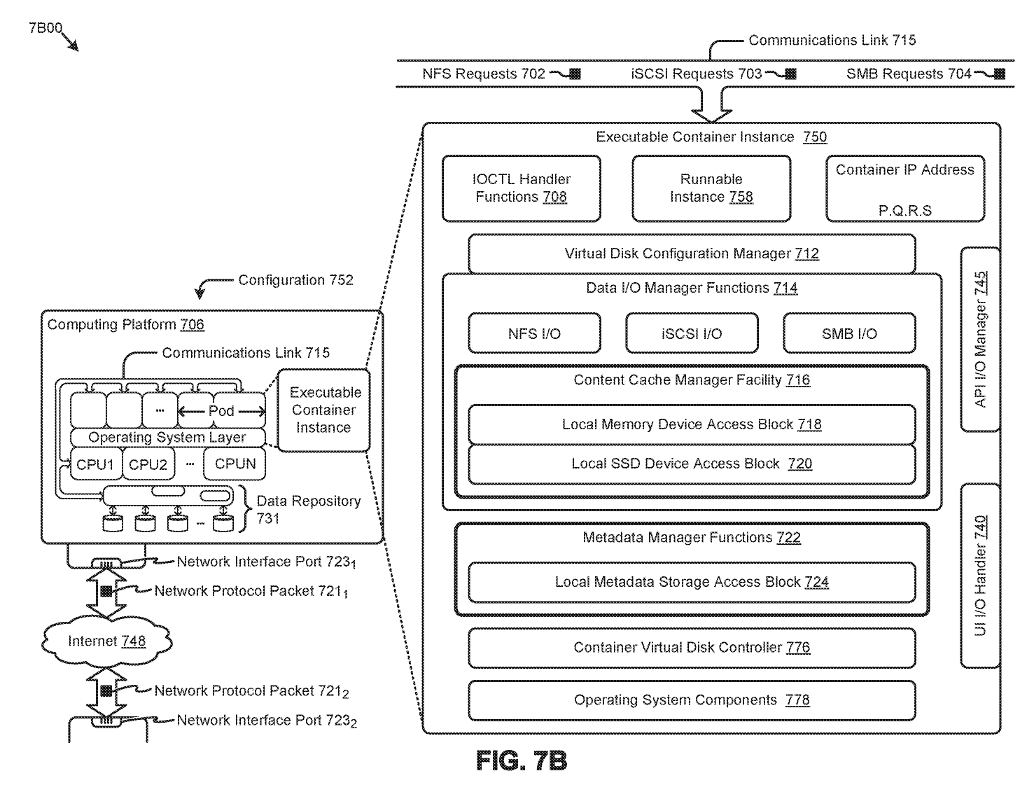

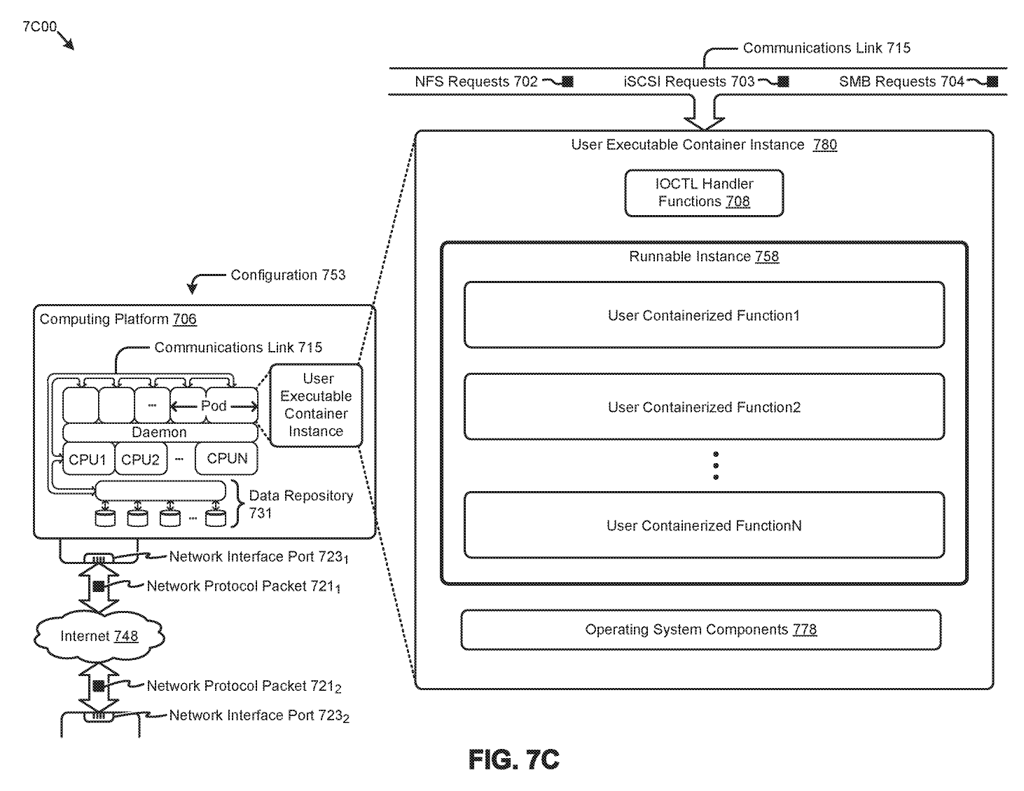

FIG. 7A depicts a virtualized controller as implemented by the shown virtual machine architecture 7A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a virtual machine instance in configuration 751 that is further described as pertaining to controller virtual machine instance 730. Configuration 751 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 730.

In this and other configurations, a controller virtual machine instance receives block I/O (input/output or IO) storage requests as network file system (NFS) requests in the form of NFS requests 702, and/or internet small computer storage interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output (I/O or IO) can be handled by one or more IO control handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS IO, iSCSI IO, SMB IO, etc.).

In addition to block IO functions, configuration 751 supports TO of any form (e.g., block IO, streaming IO, packet-based IO, HTTP traffic, etc.) through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as random access memory. As shown, controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 731, which in turn can be formatted into any one or more storage areas, and which can comprise parameterized storage accessible by a key (e.g., a filename, a table name, a block address, an offset address, etc.). External data repository 731 can store any forms of data, and may comprise a storage area dedicated to storage of metadata pertaining to the stored forms of data. In some cases, metadata can be divided into portions. Such portions and/or cache copies can be stored in the external storage data repository and/or in a local storage area (e.g., in local DRAM areas and/or in local SSD areas). Such local storage can be accessed using functions provided by local metadata storage access block 724. External data repository 731 can be configured using CVM virtual disk controller 726, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU₁, CPU₂, . . . , CPU_{N}). According to certain embodiments of the disclosure, two or more instances of configuration 751 can be coupled by communications link 715 (e.g., backplane, LAN, PSTN, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751 can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program code instructions (e.g., application code) communicated through the Internet 748 and/or through any one or more instances of communications link 715. Received program code may be processed and/or executed by a CPU as it is received and/or program code may be stored in any volatile or non-volatile storage for later execution. Program code can be transmitted via an upload (e.g., an upload from an access device over the Internet 748 to computing platform 706). Further, program code and/or the results of executing program code can be delivered to a particular user via a download (e.g., a download from computing platform 706 over the Internet 748 to an access device).

Configuration 751 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to configuring a secondary computing site from a physically-transported representation of a source computing site. In some embodiments, a module may include one or more state machines and/or combinational logic used to implement or facilitate the operational and/or performance characteristics pertaining to configuring a secondary computing site from a physically-transported representation of a source computing site.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of configuring a secondary computing site from a physically-transported representation of a source computing site). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to configuring a secondary computing site from a physically-transported representation of a source computing site, and/or for improving the way data is manipulated when performing computerized operations pertaining to physically transporting a representation of very large source site to be established at a geographically distant secondary site.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance in configuration 752 that is further described as pertaining to executable container instance 750. Configuration 752 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container. Any executable container of any sort can be rooted in a directory system, and can be configured to be accessed by file system commands (e.g., “ls” or “ls-a”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance in configuration 753 that is further described as pertaining to user executable container instance 780. Configuration 753 includes a daemon layer (as shown) that performs certain functions of an operating system.

User executable container instance 780 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 780.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository and/or any forms of network accessible storage. As such, the multiple tiers of storage may include storage that is accessible over communications link 715. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 751 of FIG. 7A) to manage the interactions between the underlying hardware and user virtual machines or containers that run client software.

Distinct from user virtual machines or user executable containers, a special controller virtual machine (e.g., as depicted by controller virtual machine instance 730) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for synchronizing a target computer cluster from data that is physically transported from a source cluster, the method comprising:
collecting data and configuration information pertaining to a primary running computing cluster situated at a first geographic location;
replicating data and configuration information of the primary running computing cluster to a seeding device configured to store a representation of the primary running computing cluster as a virtual cluster;
initiating transportation of the seeding device to a location of a secondary running computing cluster in a second geographic location; and
interfacing the seeding device to the secondary running computing cluster to establish the data and configuration information of the primary running computing cluster at the secondary computing cluster.

2. The method of claim 1, wherein the seeding device is configured to store a representation of the primary running computing cluster comprises a representation of a single node and a single node storage pool.

3. The method of claim 2, wherein the seeding device is configured to store data in an encrypted storage pool.

4. The method of claim 3, wherein the seeding device does not store keys for decrypting the data of the encrypted storage pool.

5. The method of claim 3, wherein a trusted agent holds a set of keys to decrypt the data of the encrypted storage pool.

6. The method of claim 3, further comprising applying snapshots of data and configuration of the primary running computing cluster to the secondary running computing cluster at the second geographic location.

7. The method of claim 3, further comprising applying snapshots of data and configuration of the primary running computing cluster to the seeding device.

8. The method of claim 1, further comprising capturing snapshots of data and configuration of the primary running computing cluster while the seeding device is being transported to the second geographic location.

9. The method of claim 1, further comprising forming a recommendation prior to transporting the seeding device whether or not to synchronize the target computer cluster by transmitting snapshots over a network rather than by transporting the seeding device to the second geographic location.

10. The method of claim 1, wherein a first number of nodes of the primary running computing cluster is different from a second number of nodes of the secondary running computing cluster.

11. A computer readable medium, embodied in a non-transitory computer readable medium, the non-transitory computer readable medium having stored thereon a sequence of instructions which, when stored in memory and executed by one or more processors causes the one or more processors to perform a set of acts for synchronizing a target computer cluster from data that is physically transported from a source cluster, the acts comprising:
collecting data and configuration information pertaining to a primary running computing cluster situated at a first geographic location;
replicating data and configuration information of the primary running computing cluster to a seeding device configured to store a representation of the primary running computing cluster as a virtual cluster;
causing transportation of the seeding device to a location of a secondary running computing cluster in a second geographic location; and
interfacing the seeding device to the secondary running computing cluster to establish the data and configuration information of the primary running computing cluster at the secondary computing cluster.

12. The computer readable medium of claim 11, wherein the seeding device is configured to store a representation of the primary running computing cluster comprises a representation of a single node and a single node storage pool.

13. The computer readable medium of claim 12, wherein the seeding device is configured to store data in an encrypted storage pool.

14. The computer readable medium of claim 13, wherein the seeding device does not store keys for decrypting the data of the encrypted storage pool.

15. The computer readable medium of claim 13, wherein a trusted agent holds a set of keys to decrypt the data of the encrypted storage pool.

16. The computer readable medium of claim 13, further comprising instructions which, when stored in memory and executed by the one or more processors causes the one or more processors to perform acts of applying snapshots of data and configuration of the primary running computing cluster to the secondary running computing cluster at the second geographic location.

17. The computer readable medium of claim 13, further comprising instructions which, when stored in memory and executed by the one or more processors causes the one or more processors to perform acts of applying snapshots of data and configuration of the primary running computing cluster to the seeding device.

18. The computer readable medium of claim 11, further comprising instructions which, when stored in memory and executed by the one or more processors causes the one or more processors to perform acts of capturing snapshots of data and configuration of the primary running computing cluster while the seeding device is being transported to the second geographic location.

19. A system for synchronizing a target computer cluster from data that is physically transported from a source cluster, the system comprising:
a storage medium having stored thereon a sequence of instructions; and
one or more processors that execute the instructions to cause the one or more processors to perform a set of acts, the acts comprising,
collecting data and configuration information pertaining to a primary running computing cluster situated at a first geographic location;
replicating data and configuration information of the primary running computing cluster to a seeding device configured to store a representation of the primary running computing cluster as a virtual cluster;
causing transportation of the seeding device to a location of a secondary running computing cluster in a second geographic location; and
interfacing the seeding device to the secondary running computing cluster to establish the data and configuration information of the primary running computing cluster at the secondary computing cluster.

20. The system of claim 19, wherein the seeding device is configured to store a representation of the primary running computing cluster comprises a representation of a single node and a single node storage pool.
